(19) United States
(12) Patent Application Publication
(10) Pub. No.: US 2026/0343618 A1
(43) Pub. Date: Oct. 29, 2026

(54) METHODS, SYSTEMS, AND APPARATUSES FOR PROVIDING AN ENHANCED PHYSICAL RANDOM ACCESS CHANNEL

(71) Applicant: Nokia Technologies Oy, Espoo (FI)

(72) Inventors: Mihai ENESCU, Espoo (FI); Timo KOSKELA, Oulu (FI); Sanjay GOYAL, Denville, NJ (US); Sami-Jukka HAKOLA, Oulu (FI); Juha Pekka KARJALAINEN, Sotkamo (FI)

(21) Appl. No.: 19/187,455

(22) Filed: Apr. 23, 2025

(51) Int. Cl. H04W 74/0833; H04L 1/08; H04W 74/00

(52) U.S. Cl. CPC H04W 74/0833; H04L 1/08; H04W 74/006

(57) ABSTRACT

Methods, apparatuses, and systems provide an enhanced physical random access channel (PRACH) for a communication network. In an implementation, in response to an event type associated with a user equipment being triggered, a set of physical random access channel (PRACH) sequences that corresponds to the event type is selected. Additionally, transmission of the set of PRACH sequences to indicate the event type is caused, an acknowledgment timer is initiated based on the transmission of the set of PRACH sequences, and a physical downlink control channel is monitored during the acknowledgment timer to determine whether or not to initiate a new event determination phase for the user equipment.

### TECHNOLOGICAL FIELD

An example embodiment relates generally to wireless communications and, more particularly, but not exclusively, to wireless communications associated with a physical random access channel of a communication network.

### BACKGROUND

The 3rd Generation Partnership Project (3GPP) is a standards organization which develops protocols for mobile telephony and is known for the development and maintenance of various standards including second generation (2G), third generation (3G), fourth generation (4G), Long Term Evolution (LTE), and fifth generation (5G) standards. The 5G network has been designed as a Service Based Architecture (SBA) or, in other words, a system architecture in which the system functionality is achieved by a set of network functions providing services to other authorized network functions to access their services. The 5G network may comprise a plurality of base stations (e.g., Next generation NodeB (gNB), etc.) that serve multiple cells across a particular area. Additionally, a device such as a User Equipment (UE) may be configured to connect to the 5G network. However, data transmissions between a UE and a network may be inefficiently configured and/or transmitted, especially during a random access channel procedure.

### BRIEF SUMMARY

According to some aspects, there is provided the subject matter of the independent claims. Some further aspects are defined in the dependent claims. The embodiments that do not fall under the scope of the claims are to be interpreted as examples useful for understanding the disclosure.

In an example embodiment, an apparatus is provided. In one or more embodiments, the apparatus comprises at least one processor and at least one memory storing instructions. In some embodiments, the instructions, when executed by the at least one processor, cause the apparatus to, in response to an event type associated with a user equipment being triggered, select a set of physical random access channel (PRACH) sequences that corresponds to the event type. In some embodiments, the instructions, when executed by the at least one processor, additionally or alternatively cause the apparatus to cause transmission of the set of PRACH sequences to indicate the event type. In some embodiments, the instructions, when executed by the at least one processor, additionally or alternatively cause the apparatus to initiate an acknowledgment timer based on the transmission of the set of PRACH sequences. In some embodiments, the instructions, when executed by the at least one processor, additionally or alternatively cause the apparatus to monitor a physical downlink control channel during the acknowledgment timer to determine whether or not to initiate a new event determination phase for the user equipment.

In some embodiments, the instructions, when executed by the at least one processor, additionally or alternatively cause the apparatus to cause the transmission of the set of PRACH sequences via a PRACH transmission occasion.

In some embodiments, the instructions, when executed by the at least one processor, additionally or alternatively cause the apparatus to cause the transmission of the set of PRACH sequences via a user equipment initiated (UEI) transmission occasion.

In some embodiments, the instructions, when executed by the at least one processor, additionally or alternatively cause the apparatus to monitor for an acknowledgment message via the physical downlink control channel during the acknowledgement timer. In some embodiments, the instructions, when executed by the at least one processor, additionally or alternatively cause the apparatus to, in response to a determination that the acknowledgment message is not received within the acknowledgement timer, cause retransmission of the set of PRACH sequences to the network device.

In some embodiments, the instructions, when executed by the at least one processor, additionally or alternatively cause the apparatus to cause the retransmission of the set of PRACH sequences via a PRACH transmission occasion or a user equipment initiated transmission occasion.

In some embodiments, the retransmission is conditioned on a positive triggered event in a latest evaluation window.

In some embodiments, the instructions, when executed by the at least one processor, additionally or alternatively cause the apparatus to determine whether or not the acknowledgment message is received within the acknowledgment timer based on a downlink control information (DCI). In some embodiments, the DCI indicates whether or not the apparatus is to transmit a report associated with the set of PRACH sequences.

In some embodiments, the instructions, when executed by the at least one processor, additionally or alternatively cause the apparatus to compare the acknowledgement timer value for the acknowledgement timer to a network configured time window value.

In some embodiments, the instructions, when executed by the at least one processor, additionally or alternatively cause the apparatus to, based on (i) a first determination that the acknowledgement timer value is less than the network configured time window value and (ii) a second determination that an acknowledgement message is not received via the physical downlink control channel, continue monitoring of the physical downlink control channel.

In some embodiments, the instructions, when executed by the at least one processor, additionally or alternatively cause the apparatus to, based on (i) a first determination that the acknowledgement timer value is equal to or greater than the network configured time window value and (ii) a second determination that an acknowledgement message is not received via the physical downlink control channel, initiate the new event determination phase for the user equipment initiated event type.

In some embodiments, the instructions, when executed by the at least one processor, additionally or alternatively cause the apparatus to, based on (i) a first determination that the acknowledgement timer value is less than the network configured time window value and (ii) a second determination that an acknowledgement message is received via the physical downlink control channel, cause transmission of channel state information via a physical uplink shared channel (PUSCH). In some embodiments, the instructions, when executed by the at least one processor, additionally or alternatively cause the apparatus to cause transmission of channel state information via a time slot associated with a PUSCH scheduling offset.

In some embodiments, the instructions, when executed by the at least one processor, additionally or alternatively cause the apparatus to, based on (i) a first determination that the acknowledgement timer value is equal to or greater than the network configured time window value and (ii) a second determination that an acknowledgement message is received via the physical downlink control channel, withhold transmission of channel state information via a physical uplink shared channel and initiate the new event determination phase for the user equipment initiated event type.

In some embodiments, the instructions, when executed by the at least one processor, additionally or alternatively cause the apparatus to monitor an information field associated with downlink control information received via the physical downlink control channel during the acknowledgment timer to determine whether or not to initiate the new event determination phase for the user equipment initiated event type.

In some embodiments, the set of PRACH sequences is configured to indicate at least one of: a plurality of event types, a plurality of configurations of a single event type, or a plurality of configurations of multiple event types.

In some embodiments, the set of PRACH sequences is configured in a RACH-ConfigGeneric information element or a RACH-ConfigGenericTwoStepRA information element.

In some embodiments, the RACH-ConfigGeneric information element indicates at least one of: a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, or a msg1-UEI-FrequencyStart associated with the event type.

In some embodiments, the RACH-ConfigGenericTwoStepRA information element indicates at least one of: a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, or a msgB-ResponseWindow associated with the event type.

In some embodiments, the apparatus is the user equipment. In some embodiments, the apparatus is comprised in the user equipment.

In another example embodiment, a method is provided. In some embodiments, the method comprises, in response to an event type associated with a user equipment being triggered, selecting a set of PRACH sequences that corresponds to the event type. In some embodiments, the method additionally or alternatively comprises causing transmission of the set of PRACH sequences to indicate the event type. In some embodiments, the method additionally or alternatively comprises initiating an acknowledgment timer based on the transmission of the set of PRACH sequences. In some embodiments, the method additionally or alternatively comprises monitoring a physical downlink control channel during the acknowledgment timer to determine whether or not to initiate a new event determination phase for the user equipment.

In some embodiments, the method additionally or alternatively comprises causing the apparatus to cause the transmission of the set of PRACH sequences via a PRACH transmission occasion.

In some embodiments, the method additionally or alternatively comprises causing the transmission of the set of PRACH sequences via a UEI transmission occasion.

In some embodiments, the method additionally or alternatively comprises monitoring for an acknowledgment message via the physical downlink control channel during the acknowledgement timer. In some embodiments, the method additionally or alternatively comprises, in response to a determination that the acknowledgment message is not received within the acknowledgement timer, causing retransmission of the set of PRACH sequences to the network device.

In some embodiments, the method additionally or alternatively comprises causing the retransmission of the set of PRACH sequences via a PRACH transmission occasion or a user equipment initiated transmission occasion.

In some embodiments, the retransmission is conditioned on a positive triggered event in a latest evaluation window.

In some embodiments, the method additionally or alternatively comprises determining whether or not the acknowledgment message is received within the acknowledgment timer based on a DCI. In some embodiments, the DCI indicates whether or not the apparatus is to transmit a report associated with the set of PRACH sequences.

In some embodiments, the method additionally or alternatively comprises comparing the acknowledgement timer value for the acknowledgement timer to a network configured time window value.

In some embodiments, the method additionally or alternatively comprises, based on (i) a first determination that the acknowledgement timer value is less than the network configured time window value and (ii) a second determination that an acknowledgement message is not received via the physical downlink control channel, continuing monitoring of the physical downlink control channel.

In some embodiments, the method additionally or alternatively comprises, based on (i) a first determination that the acknowledgement timer value is equal to or greater than the network configured time window value and (ii) a second determination that an acknowledgement message is not received via the physical downlink control channel, initiating the new event determination phase for the user equipment initiated event type.

In some embodiments, the method additionally or alternatively comprises, based on (i) a first determination that the acknowledgement timer value is less than the network configured time window value and (ii) a second determination that an acknowledgement message is received via the physical downlink control channel, causing transmission of channel state information via a PUSCH. In some embodiments, the method additionally or alternatively comprises causing transmission of channel state information via a time slot associated with a PUSCH scheduling offset.

In some embodiments, the method additionally or alternatively comprises, based on (i) a first determination that the acknowledgement timer value is equal to or greater than the network configured time window value and (ii) a second determination that an acknowledgement message is received via the physical downlink control channel, withholding transmission of channel state information via a physical uplink shared channel and initiate the new event determination phase for the user equipment initiated event type.

In some embodiments, the method additionally or alternatively comprises monitoring an information field associated with downlink control information received via the physical downlink control channel during the acknowledgment timer to determine whether or not to initiate the new event determination phase for the user equipment initiated event type.

In some embodiments, the set of PRACH sequences is configured to indicate at least one of: a plurality of event types, a plurality of configurations of a single event type, or a plurality of configurations of multiple event types.

In some embodiments, the set of PRACH sequences is configured in a RACH-ConfigGeneric information element or a RACH-ConfigGenericTwoStepRA information element.

In some embodiments, the RACH-ConfigGeneric information element indicates at least one of: a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, or a msg1-UEI-FrequencyStart associated with the event type.

In some embodiments, the RACH-ConfigGenericTwoStepRA information element indicates at least one of: a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, or a msgB-ResponseWindow associated with the event type.

In yet another example embodiment, a non-transitory computer-readable storage medium is provided. In some embodiments, the non-transitory computer-readable storage medium includes program instructions stored thereon that are configured to, in response to an event type associated with a user equipment being triggered, select a set of PRACH sequences that corresponds to the event type. In some embodiments, the non-transitory computer-readable storage medium additionally or alternatively includes program instructions stored thereon that are configured to cause transmission of the set of PRACH sequences to indicate the event type. In some embodiments, the non-transitory computer-readable storage medium additionally or alternatively includes program instructions stored thereon that are configured to initiate an acknowledgment timer based on the transmission of the set of PRACH sequences. In some embodiments, the non-transitory computer-readable storage medium additionally or alternatively includes program instructions stored thereon that are configured to monitor a physical downlink control channel during the acknowledgment timer to determine whether or not to initiate a new event determination phase for the user equipment.

In some embodiments, the non-transitory computer-readable storage medium additionally or alternatively includes program instructions stored thereon that are configured to cause the transmission of the set of PRACH sequences via a PRACH transmission occasion.

In some embodiments, the non-transitory computer-readable storage medium additionally or alternatively includes program instructions stored thereon that are configured to cause the transmission of the set of PRACH sequences via a UEI transmission occasion.

In some embodiments, the non-transitory computer-readable storage medium additionally or alternatively includes program instructions stored thereon that are configured to monitor for an acknowledgment message via the physical downlink control channel during the acknowledgement timer. In some embodiments, the non-transitory computer-readable storage medium additionally or alternatively includes program instructions stored thereon that are configured to, in response to a determination that the acknowledgment message is not received within the acknowledgement timer, cause retransmission of the set of PRACH sequences to the network device.

In some embodiments, the instructions, when executed by the at least one processor, additionally or alternatively cause the apparatus to cause the retransmission of the set of PRACH sequences via a PRACH transmission occasion or a user equipment initiated transmission occasion.

In some embodiments, the retransmission is conditioned on a positive triggered event in a latest evaluation window.

In some embodiments, the non-transitory computer-readable storage medium additionally or alternatively includes program instructions stored thereon that are configured to determine whether or not the acknowledgment message is received within the acknowledgment timer based on a downlink control information (DCI). In some embodiments, the DCI indicates whether or not the apparatus is to transmit a report associated with the set of PRACH sequences.

In some embodiments, the non-transitory computer-readable storage medium additionally or alternatively includes program instructions stored thereon that are configured to compare the acknowledgement timer value for the acknowledgement timer to a network configured time window value.

In some embodiments, the non-transitory computer-readable storage medium additionally or alternatively includes program instructions stored thereon that are configured to, based on (i) a first determination that the acknowledgement timer value is less than the network configured time window value and (ii) a second determination that an acknowledgement message is not received via the physical downlink control channel, continue monitoring of the physical downlink control channel.

In some embodiments, the non-transitory computer-readable storage medium additionally or alternatively includes program instructions stored thereon that are configured to, based on (i) a first determination that the acknowledgement timer value is equal to or greater than the network configured time window value and (ii) a second determination that an acknowledgement message is not received via the physical downlink control channel, initiate the new event determination phase for the user equipment initiated event type.

In some embodiments, the non-transitory computer-readable storage medium additionally or alternatively includes program instructions stored thereon that are configured to, based on (i) a first determination that the acknowledgement timer value is less than the network configured time window value and (ii) a second determination that an acknowledgement message is received via the physical downlink control channel, cause transmission of channel state information via a physical uplink shared channel (PUSCH). In some embodiments, the non-transitory computer-readable storage medium additionally or alternatively includes program instructions stored thereon that are configured to cause transmission of channel state information via a time slot associated with a PUSCH scheduling offset.

In some embodiments, the non-transitory computer-readable storage medium additionally or alternatively includes program instructions stored thereon that are configured to, based on (i) a first determination that the acknowledgement timer value is equal to or greater than the network configured time window value and (ii) a second determination that an acknowledgement message is received via the physical downlink control channel, withhold transmission of channel state information via a physical uplink shared channel and initiate the new event determination phase for the user equipment initiated event type.

In some embodiments, the non-transitory computer-readable storage medium additionally or alternatively includes program instructions stored thereon that are configured to monitor an information field associated with downlink control information received via the physical downlink control channel during the acknowledgment timer to determine whether or not to initiate the new event determination phase for the user equipment initiated event type.

In some embodiments, the set of PRACH sequences is configured to indicate at least one of: a plurality of event types, a plurality of configurations of a single event type, or a plurality of configurations of multiple event types.

In some embodiments, the set of PRACH sequences is configured in a RACH-ConfigGeneric information element or a RACH-ConfigGenericTwoStepRA information element.

In some embodiments, the RACH-ConfigGeneric information element indicates at least one of: a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, or a msg1-UEI-FrequencyStart associated with the event type.

In some embodiments, the RACH-ConfigGenericTwoStepRA information element indicates at least one of: a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, or a msgB-ResponseWindow associated with the event type.

In yet another example embodiment, an apparatus is provided. In some embodiments, in response to an event type associated with a user equipment being triggered, the apparatus provides means for selecting a set of PRACH sequences that corresponds to the event type. In some embodiments, the apparatus additionally or alternatively provides means for causing transmission of the set of PRACH sequences to indicate the event type. In some embodiments, the apparatus additionally or alternatively provides means for initiating an acknowledgment timer based on the transmission of the set of PRACH sequences. In some embodiments, the apparatus additionally or alternatively provides means for monitoring a physical downlink control channel during the acknowledgment timer to determine whether or not to initiate a new event determination phase for the user equipment.

In some embodiments, the apparatus additionally or alternatively provides means for causing the apparatus to cause the transmission of the set of PRACH sequences via a PRACH transmission occasion.

In some embodiments, the apparatus additionally or alternatively provides means for causing the transmission of the set of PRACH sequences via a UEI transmission occasion.

In some embodiments, the apparatus additionally or alternatively provides means for monitoring for an acknowledgment message via the physical downlink control channel during the acknowledgement timer. In some embodiments, in response to a determination that the acknowledgment message is not received within the acknowledgement timer, the apparatus additionally or alternatively provides means for causing retransmission of the set of PRACH sequences to the network device.

In some embodiments, the apparatus additionally or alternatively provides means for causing the retransmission of the set of PRACH sequences via a PRACH transmission occasion or a user equipment initiated transmission occasion.

In some embodiments, the retransmission is conditioned on a positive triggered event in a latest evaluation window.

In some embodiments, the apparatus additionally or alternatively provides means for determining whether or not the acknowledgment message is received within the acknowledgment timer based on a DCI. In some embodiments, the DCI indicates whether or not the apparatus is to transmit a report associated with the set of PRACH sequences.

In some embodiments, the apparatus additionally or alternatively provides means for comparing the acknowledgement timer value for the acknowledgement timer to a network configured time window value.

In some embodiments, based on (i) a first determination that the acknowledgement timer value is less than the network configured time window value and (ii) a second determination that an acknowledgement message is not received via the physical downlink control channel, the apparatus additionally or alternatively provides means for continuing monitoring of the physical downlink control channel.

In some embodiments, based on (i) a first determination that the acknowledgement timer value is equal to or greater than the network configured time window value and (ii) a second determination that an acknowledgement message is not received via the physical downlink control channel, the apparatus additionally or alternatively provides means for initiating the new event determination phase for the user equipment initiated event type.

In some embodiments, based on (i) a first determination that the acknowledgement timer value is less than the network configured time window value and (ii) a second determination that an acknowledgement message is received via the physical downlink control channel, the apparatus additionally or alternatively provides means for causing transmission of channel state information via a PUSCH. In some embodiments, the apparatus additionally or alternatively provides means for causing transmission of channel state information via a time slot associated with a PUSCH scheduling offset.

In some embodiments, based on (i) a first determination that the acknowledgement timer value is equal to or greater than the network configured time window value and (ii) a second determination that an acknowledgement message is received via the physical downlink control channel, the apparatus additionally or alternatively provides means for withholding transmission of channel state information via a physical uplink shared channel and initiate the new event determination phase for the user equipment initiated event type.

In some embodiments, the apparatus additionally or alternatively provides means for monitoring an information field associated with downlink control information received via the physical downlink control channel during the acknowledgment timer to determine whether or not to initiate the new event determination phase for the user equipment initiated event type.

In some embodiments, the set of PRACH sequences is configured to indicate at least one of: a plurality of event types, a plurality of configurations of a single event type, or a plurality of configurations of multiple event types.

In some embodiments, the set of PRACH sequences is configured in a RACH-ConfigGeneric information element or a RACH-ConfigGenericTwoStepRA information element.

In some embodiments, the RACH-ConfigGeneric information element indicates at least one of: a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, or a msg1-UEI-FrequencyStart associated with the event type.

In some embodiments, the RACH-ConfigGenericTwoStepRA information element indicates at least one of: a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, or a msgB-ResponseWindow associated with the event type.

In yet another example embodiment, a computer system is provided. In some embodiments, the computer system comprises one or more processors, at least one data storage, and one or more computer program instructions. In some embodiments, the one or more computer program instructions, to be executed by the one or more processors in association with the at least one data storage, are configured to, in response to an event type associated with a user equipment being triggered, select a set of PRACH sequences that corresponds to the event type. In some embodiments, the one or more computer program instructions, to be executed by the one or more processors in association with the at least one data storage, are configured to cause transmission of the set of PRACH sequences to indicate the event type. In some embodiments, the one or more computer program instructions, to be executed by the one or more processors in association with the at least one data storage, are configured to initiate an acknowledgment timer based on the transmission of the set of PRACH sequences. In some embodiments, the one or more computer program instructions, to be executed by the one or more processors in association with the at least one data storage, are configured to monitor a physical downlink control channel during the acknowledgment timer to determine whether or not to initiate a new event determination phase for the user equipment.

In some embodiments, the one or more computer program instructions, to be executed by the one or more processors in association with the at least one data storage, are configured to cause the transmission of the set of PRACH sequences via a PRACH transmission occasion.

In some embodiments, the one or more computer program instructions, to be executed by the one or more processors in association with the at least one data storage, are configured to cause the transmission of the set of PRACH sequences via a UEI transmission occasion.

In some embodiments, the one or more computer program instructions, to be executed by the one or more processors in association with the at least one data storage, are configured to monitor for an acknowledgment message via the physical downlink control channel during the acknowledgement timer. In some embodiments, the one or more computer program instructions, to be executed by the one or more processors in association with the at least one data storage, are configured to, in response to a determination that the acknowledgment message is not received within the acknowledgement timer, cause retransmission of the set of PRACH sequences to the network device.

In some embodiments, the one or more computer program instructions, to be executed by the one or more processors in association with the at least one data storage, are configured to cause the retransmission of the set of PRACH sequences via a PRACH transmission occasion or a user equipment initiated transmission occasion.

In some embodiments, the retransmission is conditioned on a positive triggered event in a latest evaluation window.

In some embodiments, the one or more computer program instructions, to be executed by the one or more processors in association with the at least one data storage, are configured to determine whether or not the acknowledgment message is received within the acknowledgment timer based on a downlink control information (DCI). In some embodiments, the DCI indicates whether or not the apparatus is to transmit a report associated with the set of PRACH sequences.

In some embodiments, the one or more computer program instructions, to be executed by the one or more processors in association with the at least one data storage, are configured to compare the acknowledgement timer value for the acknowledgement timer to a network configured time window value.

In some embodiments, the one or more computer program instructions, to be executed by the one or more processors in association with the at least one data storage, are configured to, based on (i) a first determination that the acknowledgement timer value is less than the network configured time window value and (ii) a second determination that an acknowledgement message is not received via the physical downlink control channel, continue monitoring of the physical downlink control channel.

In some embodiments, the one or more computer program instructions, to be executed by the one or more processors in association with the at least one data storage, are configured to, based on (i) a first determination that the acknowledgement timer value is equal to or greater than the network configured time window value and (ii) a second determination that an acknowledgement message is not received via the physical downlink control channel, initiate the new event determination phase for the user equipment initiated event type.

In some embodiments, the one or more computer program instructions, to be executed by the one or more processors in association with the at least one data storage, are configured to, based on (i) a first determination that the acknowledgement timer value is less than the network configured time window value and (ii) a second determination that an acknowledgement message is received via the physical downlink control channel, cause transmission of channel state information via a physical uplink shared channel (PUSCH). In some embodiments, the one or more computer program instructions, to be executed by the one or more processors in association with the at least one data storage, are configured to cause transmission of channel state information via a time slot associated with a PUSCH scheduling offset.

In some embodiments, the one or more computer program instructions, to be executed by the one or more processors in association with the at least one data storage, are configured to, based on (i) a first determination that the acknowledgement timer value is equal to or greater than the network configured time window value and (ii) a second determination that an acknowledgement message is received via the physical downlink control channel, withhold transmission of channel state information via a physical uplink shared channel and initiate the new event determination phase for the user equipment initiated event type.

In some embodiments, the one or more computer program instructions, to be executed by the one or more processors in association with the at least one data storage, are configured to monitor an information field associated with downlink control information received via the physical downlink control channel during the acknowledgment timer to determine whether or not to initiate the new event determination phase for the user equipment initiated event type.

In some embodiments, the set of PRACH sequences is configured to indicate at least one of: a plurality of event types, a plurality of configurations of a single event type, or a plurality of configurations of multiple event types.

In some embodiments, the set of PRACH sequences is configured in a RACH-ConfigGeneric information element or a RACH-ConfigGenericTwoStepRA information element.

In some embodiments, the RACH-ConfigGeneric information element indicates at least one of: a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, or a msg1-UEI-FrequencyStart associated with the event type.

In some embodiments, the RACH-ConfigGenericTwoStepRA information element indicates at least one of: a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, or a msgB-ResponseWindow associated with the event type.

This summary is intended to provide a brief overview of some of the aspects and features according to the subject disclosure. Accordingly, it will be appreciated that the above-described features are merely examples and should not be construed to narrow the scope of the subject disclosure in any way. Other features, aspects, and advantages of the subject disclosure will become apparent from the following detailed description, drawings and claims.

### BRIEF DESCRIPTION OF THE DRAWINGS

A better understanding of the subject disclosure may be obtained when the following detailed description of various embodiments is considered in conjunction with the following drawings, in which:

FIG. 1 shows a schematic diagram of an example communication network, in accordance with one or more embodiments of the present disclosure;

FIG. 2 shows a schematic diagram of an example user equipment, in accordance with one or more embodiments of the present disclosure;

FIG. 3 shows a schematic diagram of an example network node, in accordance with one or more embodiments of the present disclosure;

FIG. 4 is an example signal flow diagram illustrating example transmissions associated with a user equipment (UE) initiated beam management timeline that utilizes enhanced physical random access channel (PRACH), in accordance with one or more embodiments of the present disclosure;

FIG. 5 is another example signal flow diagram illustrating example transmissions associated with a UE initiated beam management timeline that utilizes enhanced PRACH, in accordance with one or more embodiments of the present disclosure;

FIG. 6 is an example signal flow diagram illustrating example transmissions between a UE and a network entity, in accordance with one or more embodiments of the present disclosure;

FIG. 7 illustrates an example RACH-ConfigGeneric information element associated with a set of PRACH sequences, in accordance with one or more embodiments of the present disclosure;

FIG. 8 illustrates an example RACH-ConfigGenericTwoStepRA information element associated with a set of PRACH sequences, in accordance with one or more embodiments of the present disclosure;

FIG. 9 is a flowchart of operations according to certain example embodiments implemented, for example, by an apparatus as described herein;

FIG. 10 is a flowchart of operations according to certain example embodiments implemented, for example, by an apparatus as described herein;

FIG. 11 is a flowchart of operations according to certain example embodiments implemented, for example, by an apparatus as described herein;

FIG. 12 is a flowchart of operations according to certain example embodiments implemented, for example, by an apparatus as described herein;

FIG. 13 is a flowchart of operations according to certain example embodiments implemented, for example, by an apparatus as described herein; and

FIG. 14 is a flowchart of operations according to certain example embodiments implemented, for example, by an apparatus as described herein.

### DETAILED DESCRIPTION

The examples and embodiments set forth below represent information to enable those skilled in the art to practice the subject disclosure. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

The following embodiments are examples. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Further, when a particular feature, structure, or characteristic is described in connection of an embodiment, it is within the knowledge of one skilled in the art to apply such feature, structure, or characteristic in connection with other embodiments whether or not explicitly described. It shall be understood that although the terms “first,” “second” and the like may be used herein to describe various elements, these elements should not be limited by these terms. These terms are only used to distinguish one element from another.

For the purposes of the present disclosure, the phrases “at least one of A or B”, “at least one of A and B”, and “A and/or B” means (A), (B), or (A and B). For the purposes of the present disclosure, the phrase “A, B, and/or C” means (A), (B), (C), (A and B), (A and C), (B and C), or (A, B, and C).

As used herein, “plurality” means two or more. As used herein, a “set” of items may include one or more of such items. As used herein, whether in the subject disclosure or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims or the subject disclosure to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements. As used herein, “and/or” and “at least one of” means that the listed items are alternatives, but the alternatives also include any combination of the listed items.

Like reference numerals refer to like elements throughout. As used herein, the terms “data,” “content,” “information,” and similar terms may be used interchangeably to refer to data capable of being transmitted, received and/or stored in accordance with an embodiment of the present disclosure. Thus, use of any such terms should not be taken to limit the spirit and scope of one or more embodiments of the present disclosure.

As used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As defined herein, a “computer-readable storage medium,” which refers to a physical storage medium (e.g., volatile or non-volatile memory device), may be differentiated from a “computer-readable transmission medium,” which refers to an electromagnetic signal.

Embodiments described may be implemented in a communication network, such as any of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE), 5G (also called NR), or any future RAT such as 6G. Moreover, communication within the communication network may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), and/or Discrete Fourier Transform spread OFDM (DFT-s-OFDM).

Additionally, embodiments described herein may be implemented in connection with a User Equipment (UE), a Random Access (RA), a Random Access Occasion (RO), a Random Access Channel (RACH), a Physical Random Access Channel (PRACH), User Equipment Initiated Beam Management (UEIBM), Channel State Information (CSI), downlink control information (DCI), a Physical Downlink Shared Channel (PDSCH), a Physical Uplink Shared Channel (PUSCH), Frequency Division Multiplexing (FDM), a Reference Signal Received Power (RSRP), a Channel Quality Indicator (CQI), a Precoding Matrix Indicator (PMI), a Rank Indicator (RI), a Modulation and Coding Scheme (MCS), and/or a Sounding Reference Signal (SRS).

As used herein, the term “network device” or “network node” refers to a node in a communication network via which user equipment may access the network and/or which is capable of controlling radio communication and managing radio resources within a cell. The network node or network device may be referred to as a base station (BS), an access point (AP) or an access node. The network device may be, depending on the applied technology, for example, a node B (NodeB or NB), an evolved NodeB (eNodeB or eNB), an NR NB (also referred to as a gNB), a Remote Radio Unit (RRU), a radio head (RH), a remote radio head (RRH), a relay, an Integrated Access and Backhaul (IAB) node, a low power node, a non-terrestrial network (NTN) or non-ground network device such as a satellite network device, a low earth orbit (LEO) satellite and a geosynchronous earth orbit (GEO) satellite, or an aircraft network device.

Moreover, in connection of split radio access network (RAN), the network device may refer to a centralized unit (CU) of a base station and/or a distributed unit (DU) of a base station. An interface between CU and DU may be referred to as an F1 interface in NR. In the split RAN architecture, node operations may be carried out, at least partly, in the central/centralized unit, CU, (e.g., server, host, or node) operationally coupled to the DU, (e.g. a radio head/node). One CU may control one or more DUs, acting at least as transmit/receive (Tx/Rx) nodes. In some embodiments, the DUs may comprise e.g. a radio link control (RLC), medium access control (MAC) layer and a physical (PHY) layer, whereas the CU may comprise the layers above RLC layer, such as a packet data convergence protocol (PDCP) layer, a radio resource control (RRC) and an internet protocol (IP) layers. Other functional splits are possible too. In practice, any processing task may be performed in either the CU or the DU and the boundary where the responsibility is shifted between the CU and the DU may depend on the applied implementation.

The term “terminal device” refers to any end device that may be capable of wireless communication. By way of example, a terminal device may be referred to as a communication device, a UE, a Subscriber Station (SS), or a Mobile Station (MS). The terminal device may include a mobile phone, a cellular phone, a smart phone, voice over IP (VoIP) phones, wireless local loop phones a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, USB dongles, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like.

The term “resource”, as used herein, may refer to radio resources in time domain, in frequency domain, in space domain, and/or in code domain. Some examples of resources include e.g., a physical resource block (PRB), a radio frame, a subframe, a time slot, a sub-band, a frequency region, a sub-carrier, a beam, etc. The term “transmission” and/or “reception” may refer to wirelessly transmitting and/or receiving via a wireless propagation channel on radio resources.

Communication networks (e.g., wireless communication networks) employ a variety of technologies and use various standards throughout the world. There are generally agreed upon standards that promote some degree of unity between networks, with some of those standards being defined by 3GPP (3^{rd} Generation Partnership Project), such as the Third Generation (3G), a Fourth Generation (4G), and/or a next generation (e.g., Fifth Generation, or 5G) network. 5G is the fifth generation of the technology standard for broadband cellular networks. These standards provide an architecture through which user equipment (UE) can communicate with networks and other UE devices.

Certain example embodiments will be illustrated herein in conjunction with example communication systems and associated techniques to provide improved wireless communications associated with a physical random access channel of a communication network. It should be understood, however, that the scope of the claims is not limited to particular types of communication networks, communication systems, and/or processes disclosed. An example embodiment can be implemented in a terminal device (e.g., a user equipment) or a network (e.g., a communication network) of a communication system, using alternative processes and operations. For example, although illustrated in the context of wireless cellular systems utilizing 3GPP system elements such as a 3GPP next generation core network, the disclosed embodiment can be adapted in a straightforward manner to a variety of other types of communication systems. Additionally, while the present disclosure may describe certain embodiments in conjunction with a 5G communication system, other embodiments also apply to and comprise other networks and network technologies, such as 3G, 4G, Long Term Evolution (LTE), 6G, etc. without limitation.

In accordance with an illustrative embodiment implemented in a 5G communication system environment, one or more 3GPP technical specifications (TS) and technical reports (TR) provide further explanation of user equipment and core network elements/entities/functions and/or operations performed by the user equipment and the core network elements/entities/functions. However, while an illustrative embodiment is well-suited for implementation associated with the above-mentioned 3GPP standards for 5G, an alternative embodiment is not necessarily intended to be limited to any particular standards.

In certain communication systems, data collection associated with a UE and/or a communication network can be utilized for mobility decisions, beam selection decisions, calculating a position of a UE, and/or one or more other network functions. For example, a particular protocol such as Radio Resource Control (RRC) or LTE Positioning Protocol (LPP) may be utilized to configure physical layer signals. For beam selection and channel state information (CSI) reporting, physical layer messages such as physical uplink shared channel (PUSCH) and physical uplink control channel (PUCCH) may be utilized. In another example, RRC Measurement reports may be utilized for mobility decisions and/or LPP Provide Location Information messages may be utilized for positioning calculations.

In a contention based random access channel (RACH) procedure (CBRA), when a UE transmits a physical random access channel (PRACH) preamble, the UE may transmit the PRACH preamble with a specific pattern called a “Signature.” For example, in each LTE cell, a total of 64 preamble signatures may be available and a UE may randomly select one of these signatures. The “contention” of this form of RACH procedure comes from the fact that multiple UEs may send PRACH with identical signatures. As such, a contention resolution step for a communication network may mitigate technical issues associated with a contention. In a contention free RACH procedure (CFRA), a communication network may allocate these preamble signatures to avoid a collision. In LTE and NR there are long and short PRACH sequences. The short sequences are only in NR, with a length equal to 139 and nine different preamble formats, to target the small/normal cell and indoor deployment scenarios. For example, the short sequences may correspond to A1, A2, A3, B1, B2, B3, B4, C0, C2. As such, a communication system may create a RACH occasion (RO) based on a RACH parametrization. However, to enable availability for RACH transmission, a RACH occasion may create a scheduler difficulty such that the gNB may be associated with a scheduling restriction for the transmission of PDCCH, PDSCH, and/or CSI-RS. In addition, it is desirable to configure a RO to not overlap with SSBs

In UE initiated (UEI) operation, a set of events are configured to the UE for monitoring. For example, in UE Initiated Beam Management (UEIBM) an event may be triggered when the L1-RSRP of the current serving beam is lower than a threshold. In another example, an event may be triggered under certain conditions for a consecutive amount of evaluations and/or during a predefined time window. Once an event is triggered, a UE may inform a gNB by transmitting a 1 bit PUCCH signaling to the gNB. In certain instances, the gNB may schedule a PUSCH transmission so that the UEIBM report is transmitted. However, one technical issue during UE initiated triggering is the speed of signaling. With current communication networks, a UE is configured to wait until a PUCCH transmission occasion is available. The PUCCH transmission occasion may be available periodically, thereby introducing latency to the reporting. As such, in certain instances, a UEI operation is unable to inform the gNB of the new channel conditions at the UE within a desirable interval of time.

It is to be appreciated that there be other forms of UE Initiated event based procedures. For example, in UE Initiated CQI reporting, the UE may compare the CQI computed based on the serving reference signal, with one or multiple CQI values computed for other reference signals indicated by the gNB. If the later CQI is greater than the CQI computed based on the serving reference signal, an event instance is counted for a UEI CQI. In yet another example, in UE Initiated PMI reporting, the UE may compare the PMI computed based on the serving reference signal, with one or multiple PMIs computed for other reference signals indicated by the gNB. If the throughput achieved by the later PMI is greater than the throughput achieved by the PMI computed based on the serving reference signal, an event instance is counted for a UEI PMI. In yet another example, in UE Initiated Rank Indicator (RI) reporting, the UE may compare the RI computed based on the serving reference signal, with one or multiple RIs computed for other reference signals indicated by the gNB. If the throughput achieved by the later RI is greater than the throughput achieved by the RI computed based on the serving reference signal, an event instance is counted for a UEI RI. In yet another example, in UE Initiated MCS reporting, the UE may compare the MCS computed based on the serving reference signal, with one or multiple MCSs computed for other reference signals indicated by the gNB. If the throughput achieved by the later MCS is greater than the throughput achieved by the MCS computed based on the serving reference signal, an event instance is counted for a UEI MCS. In yet another example, in UE Initiated Layer Indicator (LI) reporting, the UE may compare the LI computed based on the serving reference signal, with one or multiple LIs computed for other reference signals indicated by the gNB. If the later LI is greater than the throughput achieved by the LI computed based on the serving reference signal, an event instance is counted for a UEI LI. In yet another example, in UE Initiated Layer Imbalance (LImb) reporting, the UE may compare the LImb computed based on the serving reference signal, with one or multiple LImbs computed by the UE based on different layer imbalance compensation factors. If the throughput achieved by the later LImbs is greater than the throughput achieved by the LImb computed based on the serving reference signal, an event instance is counted for a UEI LImb. In yet another example, in UE Reference signal configuration reporting, the UE may compare a UE-computed metric based on the serving reference signal configuration, with one or multiple UE-computed metrics based on other reference signals configurations such as difference time/frequency/cycling arrangements of the resource elements which are defining the reference signal pattern. If the throughput achieved by one of the later RS parameterization is greater than the throughput achieved by the serving reference signal, an event instance is counted for a UEI RS. In yet another example, in UE Initiated CPU reporting, the UE may compare the CPU needs based on the configured operations by the gNB, with one or multiple other set of operations which result in different CPU needs/budgets. If the later CPU is or smaller than the CPU achieved based on the serving reference signal, an event instance is counted for a UEI CPU. In yet another example, in UE Initiated Control Channel reporting, the UE may compare the Control Channel aggregation level and related control channel decoding needs based on the scheduled control channel information, with one or multiple other control channel aggregation levels and related control channel decoding needs which are alternative control channel scheduling variants indicated by the gNB. If the UE indicates that an alternative control channel aggregation level is better than the scheduled control channel decoding, an event instance is counted for a UEI Control Channel transmission. In yet another example, in UE Initiated Resource Allocation reporting, the UE may compare the scheduled resource allocation, with one or multiple resource allocations indicated by the gNB. If the UE indicates that an alternative resource allocation is better than the scheduled resource allocation, an event instance is counted for a UEI Resource allocation. In yet another example, in UE Initiated Multi Panel Indication, the UE may compare an existing Multi Panel operation used by the UE for an existing transmission, with one or multiple Multi Panel arrangements which are alternative transmission strategies. If the UE indicates that an alternative Multi Panel arrangement is better than the existing Multi Panel arrangement, an event instance is counted for a UEI Multi Panel Arrangement. In yet another example, in UE Initiated Beam Failure Recovery (BFR), the UE may compare an existing BFR operation used by the UE for an existing transmission, with one or multiple BFR arrangements which are alternative BFR strategies. If the UE indicates that an alternative BFR arrangement is better than the existing BFR arrangement, an event instance is counted for a UEI BFR Arrangement.

As such, described herein are methods, apparatuses, and computer program products for providing enhanced PRACH for a communication network to resolve some or all of the described limitations of current communication networks and/or current network protocols. The enhanced PRACH disclosed herein may enable reduced latency for UEI transmission of event trigger information. For example, the enhanced PRACH disclosed herein may enable a UE to transmit event trigger information in a similar manner as the transmission of the random access channel (e.g., the first channel that the UE is able to execute for establishing UL connectivity), even when coming from modes such as IDLE or INNACTIVE. In various embodiments, the enhanced PRACH disclosed herein may utilize a RACH design in a particular manner that is beneficial for UEI reporting via a communication network.

In various embodiments, a PRACH sequence design may be utilized (e.g., re-utilized) for a UEI indication of an event triggered at a UE. For example, the enhanced PRACH disclosed herein may provide one or more procedures to support operation of a UE triggered event operation based on parameterization of UEI sequences and/or UE signaling. For example, parametrization of UEI sequences may include allocating to the UE a set of sequences which may be utilized for UE triggered event indication. In some embodiments, the set of sequences may include a subset of a set of PRACH sequences utilized and/or allocated for a CBRA based PRACH procedure. In some embodiments, the set of sequences may include a subset of a set of PRACH sequences utilized and/or allocated for a CFRA based PRACH procedure. In some embodiments, the set of sequences may include a different set of sequences as configured for PRACH, where the sequences include a corresponding design as the PRACH sequences or a different design than a PRACH sequence. In some embodiments, when a configured UE event is triggered, the UE may select a sequence (e.g., a predefined sequence) to indicate the triggered status to the gNB.

In some embodiments where multiple events are triggered, the UE may utilize a sequence which is preconfigured to indicate a bundle of event configurations. In some embodiments, a single sequence may indicate multiple events. In some embodiments, a single sequence may indicate two configurations of a single event. In some embodiments where multiple events are triggered, the UE may transmit per event sequences in a time division multiplexing (TDM) form. In some embodiments, the UE may transmit the UEI sequence in a PRACH occasion. In some embodiments, the UE may transmit the UEI sequence in a designated UEI occasion. In some embodiments, transmission of the UEI sequence may be provided via a contention-based mode. In some embodiments, transmission of the UEI sequence may be provided via a contention-free modes. In some embodiments related to a contention-based transmission, after the transmission of the UEI sequence on PRACH, the UE may initiate an acknowledgement timer during which the UE may expect to receive an acknowledgement from the gNB with respect to the correct reception of the transmission. In some embodiments where the scheduling DCI is not received (e.g., which can be used as an implicit acknowledgement), the UE may retransmit the UEI sequence in a next available RACH occasion or a next available UEI occasion. The retransmission may be conditioned by the existence of a positive triggered event in the latest evaluation window, otherwise the previous event trigger may be dropped. In some embodiments, the DCI may include information whether or not the UE would transmit report(s) associated to the transmitted PRACH sequence. For example, a PRACH sequence may be provided in the DCI, used as a CRC mask for the PDCCH carrying DCI, or used as part of the scrambling code for the PDCCH carrying DCI. In some embodiments, the UE may receive a scheduling DCI for PUSCH transmission to indicate an acknowledgement of a UEI sequence.

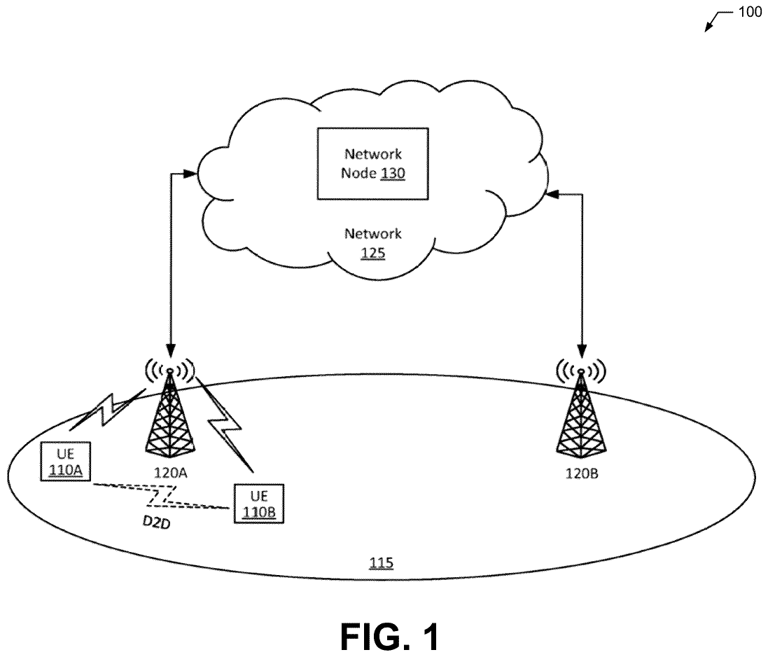

Before explaining the examples according to the subject disclosure in detail, certain general principles of a wireless communication system are briefly explained with reference to FIGS. 1 to 3 to assist in understanding the technology underlying the described examples.

FIG. 1 illustrates an example of a communication network 100 that may be used for wireless communications. The communication network 100 may be a wireless network. In one or more embodiments, the communication network 100 includes wireless devices, such as UEs 110 (e.g., 110A-110B), and network nodes 120/130, such as radio access nodes 120 (e.g., 120A-120B, which may be network nodes like eNBs, gNBs, etc.), connected to one or more further network nodes 130 over an interconnecting network 125. The communication network 100 may use any suitable deployment scenarios. UEs 110 within coverage area 115 may each be capable of communicating directly with radio access nodes 120 over a wireless or air interface. In some embodiments, UEs 110 may also be capable of communicating with each other via D2D communication.

As an example, UE 110A may communicate with radio access node 120A over a wireless or air interface. That is, UE 110A may transmit wireless signals to and/or receive wireless signals from radio access node 120A. The wireless signals may contain voice traffic, data traffic, control signals, and/or any other suitable information.

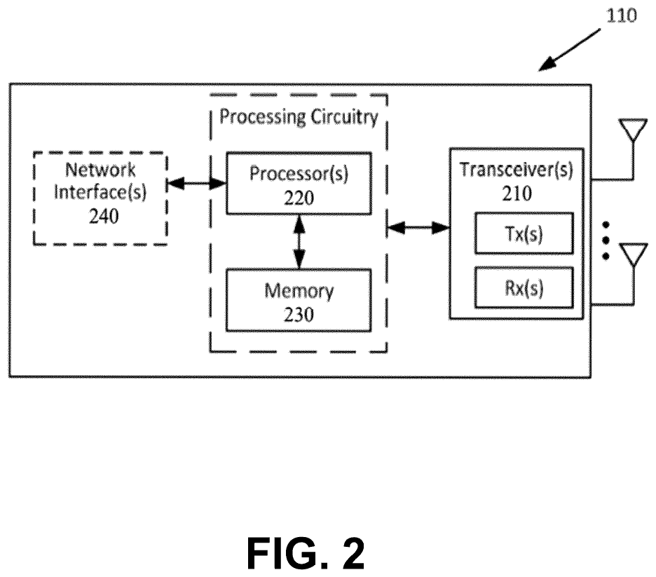

As used herein, the term “user equipment” (UE) (e.g., UE 110) has the full breadth of its ordinary meaning and may refer to any type of wireless device which may communicate with a network node (e.g., network node 120) and/or with another UE (e.g., different to UE 110) in a cellular or mobile or wireless communication system. Examples of UE are target device, D2D UE, machine type UE or UE capable of machine-to-machine (M2M) communication, personal digital assistant, tablet, mobile terminal, smart phone, laptop embedded equipped (LEE), laptop mounted equipment (LME), USB dongles, ProSe UE, vehicle-to-vehicle (V2V) UE, V2X UE, MTC UE, eMTC UE, FeMTC UE, UE Cat 0, UE Cat Ml, narrow band IoT (NB-IoT) UE, UE Cat NB1, etc. Example embodiments of a UE are described in more detail below with respect to FIG. 2.

In some embodiments, an area of wireless signal coverage 115 associated with a radio access node (e.g., 120) may be referred to as a cell. However, particularly with respect to the 5^{th} generation (5G)/New Radio (NR) mobile communication concepts, beams, such as the herein described multicast radio beams (MRBs) may be used within cells for communication.

With respect to a beam-based mobile communication system, the radio access node/base station (e.g., network node 120) may transmit a beamformed signal to the UE 110 in one or more transmit directions (transmission beam, Tx beam). The UE 110 may receive the beamformed signal from the network node 120 in one or more receive directions (reception beam, Rx beam). The UE 110 may also transmit a beamformed signal to the network node 120 in one or more directions and the network node 120 may receive the beamformed signal from the UE 110 in one or more directions. The network node 120 and the UE 110 may determine optimal receive and transmit directions, e.g., optimal in the sense of these directions leading to the highest link quality or fulfilling other quality conditions in the most suitable manner, for each base station/UE pair.

The interconnecting network 125 may refer to any interconnecting system capable of transmitting audio, video, signals, data, messages, etc., or any combination of the preceding. The interconnecting network 125 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the network node 130 may be a core network node, managing the establishment of communication sessions and other various other functionalities for UEs 110. Examples of network node 130 may include mobile switching center (MSC), MME, serving gateway (SGW), packet data network gateway (PGW), operation and maintenance (O&M), operations support system (OSS), SON, positioning node (e.g., Enhanced Serving Mobile Location Center, E-SMLC), location server node, Minimization of Drive Tests (MDT) node, etc. UEs 110 may exchange certain signals with the network node 130 using the non-access stratum (NAS) layer. In non-access stratum signaling, signals between UEs 110 and the network node 130 may be transparently passed through the radio access network. In some embodiments, radio access nodes 120 may interface with one or more network nodes 130 over an internode interface.

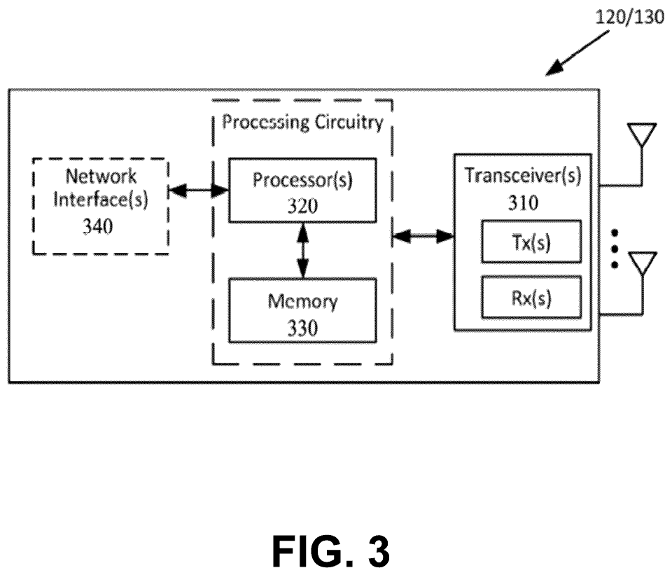

As used herein, the term “network node” has the full breadth of its ordinary meaning and may correspond to any type of radio access node (e.g., network node 120) or any network node, which may communicate with a UE and/or with another network node in a cellular or mobile or wireless communication system. Examples of network nodes are NodeB, MeNB, SeNB, a network node may belonging to MCG or SCG, base station (BS), multi-standard radio (MSR) radio access node such as MSR BS, eNodeB, network controller, radio network controller (RNC), base station controller (BSC), relay, donor node controlling relay, base transceiver station (BTS), access point (AP), transmission point, transmission node, RRU, RRH, node in distributed antenna system (DAS), core network node (e.g., MSC, MME, etc.), O&M, OSS, Self-organizing Network (SON), positioning node (e.g., E-SMLC), MDT, test equipment, etc. Example embodiments of a network node are described in more detail below with respect to FIG. 3.

In some embodiments, network node 120 may be a distributed radio access node. The components of the radio access node 120, and their associated functions, may be separated into two main units (or sub-radio network nodes) which may be referred to as the central unit (CU) and the distributed unit (DU). Different distributed radio network node architectures are possible. For instance, in some architectures, a DU may be connected to a CU via dedicated wired or wireless link (e.g., an optical fiber cable) whereas in other architectures, a DU may be connected a CU via a transport network. Also, how the various functions of the network node 120 are separated between the CU(s) and DU(s) may vary depending on the chosen architecture.

In some embodiments, network nodes 120 may communicate with each other over terrestrial or other connections. The communication between the network nodes 120 may, e.g., in a 5G/NR communication system may be achieved by using an Xn interface connecting the network nodes 120.

Example wireless communication systems are architectures standardized by the 3rd Generation Partnership Project (3GPP). A latest 3GPP based development is often referred to as the long-term evolution (LTE) of the Universal Mobile Telecommunications System (UMTS) radio-access technology (RAT). The various development stages of the 3GPP specifications are referred to as releases. More recent developments of the LTE are often referred to as LTE Advanced (LTE-A). The LTE (LTE-A) employs a radio mobile architecture known as the Evolved Universal Terrestrial Radio Access Network (E-UTRAN) and a core network known as the Evolved Packet Core (EPC). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other RAT examples comprise those provided by base stations of systems that are based on technologies such as WLAN and/or Worldwide Interoperability for Microwave Access (WiMax). A base station may provide coverage for an entire cell or similar radio service area. Core network elements include Mobility Management Entity (MME), Serving Gateway (S-GW) and Packet Gateway (P-GW).

An example of a suitable communications system is the 5G or NR concept. Network architecture in NR may be similar to that of LTE-A. Base stations of NR systems may be known as next generation Node Bs (gNBs). Changes to the network architecture may depend on the need to support various radio technologies and finer Quality of Service (QoS) support, and some on-demand requirements for QoS levels to support Quality of Experience (QoE) of user point of view. Also network aware services and applications, and service and application aware networks may bring changes to the architecture. Those are related to Information Centric Network (ICN) and User-Centric Content Delivery Network (UC-CDN) approaches. NR may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes, or hosts. It should also be understood that the distribution of labor between core network operations and base station operations may differ from that of the LTE or even be non-existent.

An example 5G core network (CN) comprises functional entities. The CN is connected to a UE via the radio access network (RAN). An UPF (User Plane Function) whose role is called PSA (PDU Session Anchor) may be responsible for forwarding frames back and forth between the DN (data network) and the tunnels established over the 5G towards the UEs exchanging traffic with the data network (DN). The UPF is controlled by an SMF (Session Management Function) that receives policies from a PCF (Policy Control Function). The CN may also include an AMF (Access & Mobility Function).

Generally, all concepts disclosed herein may be applicable to different communication networks, comprising but not limited to LTE, LTE-A, 5G, 5G advanced, 6G, and other future or already implemented networks.

FIG. 2 is a schematic diagram of an apparatus for the UE 110. In an embodiment, the apparatus may comprise the UE 110, in yet another embodiment the apparatus is comprised in the UE 110, and in another embodiment the apparatus is the UE 110. The apparatus may comprise a wireless device. The apparatus may comprise at least one processor 220 and at least memory 230 storing computer program instructions that, when executed by the at least one processor 220, cause the apparatus to carry out the embodiments of the UE 110 described herein. UE 110 includes a transceiver 210, processor 220, memory 230, and a network interface 240. In some embodiments, the transceiver 210 facilitates transmitting wireless signals to and receiving wireless signals from radio access node 120 (e.g., via transmitter(s) (Tx), receiver(s) (Rx) and antenna(s)). The processor 220 executes instructions to provide some or all of the functionalities described herein as being provided by UE 110, and the memory 230 stores the instructions executed by the processor 220. In some embodiments, the processor 220 and the memory 230 form processing circuitry.

The processor 220 may include any suitable combination of hardware to execute instructions and manipulate data to perform some or all of the described functions of UE 110 described herein. In some embodiments, the processor 220 may include, for example, one or more computers, one or more central processing units (CPUs), one or more microprocessors, one or more application specific integrated circuits (ASICs), one or more field programmable gate arrays (FPGAs) and/or other logic.

The memory 230 is generally operable to store instructions, such as a computer program, software, an application including one or more of logic, rules, algorithms, code, tables, etc. and/or other instructions capable of being executed by a processor 220. Examples of memory 230 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor 220 of UE 110. For example, the memory 230 includes computer program code causing the processor 220 to perform processing according to the methods described herein.

The network interface 240 is communicatively coupled to the processor 220 and may refer to any suitable device operable to receive input for UE 110, send output from UE 110, perform suitable processing of the input or output or both, communicate to other devices, or any combination thereof. The network interface 240 may include appropriate hardware (e.g., port, modem, network interface card, etc.) and software, including protocol conversion and data processing capabilities, to communicate through a network.

Other embodiments of UE 110 may include additional components beyond those shown in FIG. 2 that may be responsible for providing certain aspects of the wireless device's functionalities, including any of the functionalities described herein and/or any additional functionalities (including any functionality necessary to support the mechanisms according to the subject disclosure). As an example, UE 110 may include input devices and circuits, output devices, and one or more synchronization units or circuits, which may be part of the processor 220. Input devices include mechanisms for entry of data into UE 110. For example, input devices may include input mechanisms, such as a microphone, input elements, a display, etc. Output devices may include mechanisms for outputting data in audio, video and/or hard copy format. For example, output devices may include a speaker, a display, etc.

In some embodiments, the wireless device UE 110 may comprise a series of modules configured to implement the functionalities of the wireless device described herein. Moreover, in some embodiments, the UE 110 may also comprise means for the functionalities described herein. A non-transitory computer readable medium with computer executable instructions stored thereon executed by the processor 220 of the UE 110 to perform the functionalities as described herein may also be provided.

It will be appreciated that the various modules may be implemented as combination of hardware and software, for instance, the processor, memory, and transceiver(s) of UE 110 shown in FIG. 2. Some embodiments may also include additional modules to support additional and/or optional functionalities.

FIG. 3 is a schematic diagram of an example of an apparatus for a radio access node 120 or network node 130. The apparatus may comprise at least one processor 220 and at least memory 230 storing computer program instructions that, when executed by the at least one processor 220, cause the apparatus to carry out the embodiments of the core network node 130 or radio access node 120 described herein. The example a radio access node (e.g., 120) or a core network node (e.g., 130) may include one or more of a transceiver 310, processor 320, memory 330, and network interface 340. In some embodiments, the transceiver 310 facilitates transmitting wireless signals to and receiving wireless signals from wireless devices, such as UE 110 (e.g., via transmitter(s) (Tx), receiver(s) (Rx), and antenna(s)). The processor 320 executes instructions to provide some or all of the functionalities described herein as being provided by a radio access node (e.g., 120) or a core network node (e.g., 130), the memory 330 stores the instructions executed by the processor 320. In some embodiments, the processor 320 and the memory 330 form processing circuitry. The network interface 340 may communicate signals to backend network components, such as a gateway, switch, router, Internet, Public Switched Telephone Network (PSTN), core network nodes or radio network controllers, etc.

The processor 320 may include any suitable combination of hardware to execute instructions and manipulate data to perform some or all of the described functions of a radio access node (e.g., 120) or a core network node (e.g., 130), such as those described herein. In some embodiments, the processor 320 may include, for example, one or more computers, one or more central processing units (CPUs), one or more microprocessors, one or more application specific integrated circuits (ASICs), one or more field programmable gate arrays (FPGAs) and/or other logic.

The memory 330 is generally operable to store instructions, such as a computer program, software, an application including one or more of logic, rules, algorithms, code, tables, etc. and/or other instructions capable of being executed by a processor 320. Examples of memory 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information. For example, the memory 330 includes computer program code causing the processor 320 to perform processing according to the methods described herein.

In some embodiments, the network interface 340 is communicatively coupled to the processor 320 and may refer to any suitable device operable to receive input for a radio access node (e.g., 120) or a core network node (e.g., 130), send output from a radio access node (e.g., 120) or a core network node (e.g., 130), perform suitable processing of the input or output or both, communicate to other devices, or any combination of the preceding. The network interface 340 may include appropriate hardware (e.g., port, modem, network interface card, etc.) and software, including protocol conversion and data processing capabilities, to communicate through a network.

Other embodiments of a radio access node (e.g., 120) or a core network node (e.g., 130) may include additional components beyond those shown in FIG. 3 that may be responsible for providing certain aspects of the node's functionalities, including any of the functionalities described herein and/or any additional functionalities (including any functionality necessary to support the solutions described herein). The various different types of radio access nodes or core network nodes may include components having the same physical hardware but configured (e.g., via programming) to support different radio access technologies, or may represent partly or entirely different physical components.

Processors, interfaces, and memory similar to those described with respect to FIG. 3 may be included in other nodes (such as UE 110, network node 120, etc.). Other nodes may optionally include or not include a wireless interface (such as the transceiver described in FIG. 3).

In some embodiments, the radio access node 120 or the core network node 130 may comprise a series of modules configured to implement the functionalities of the radio access node 120 or the core network node 130 described herein. Moreover, in some embodiments, the radio access node 120 or the core network node 130 may also comprise means for the functionalities described herein. A non-transitory computer readable medium with computer executable instructions stored thereon executed by the processor 320 of the network node 120/130 to perform the functionalities as described herein may also be provided.

It will be appreciated that the various modules may be implemented as combination of hardware and software, for instance, the processor, memory, and transceiver(s) of the radio access node 120 or the core network node 130 shown in FIG. 3. Some embodiments may also include additional modules to support additional and/or optional functionalities.

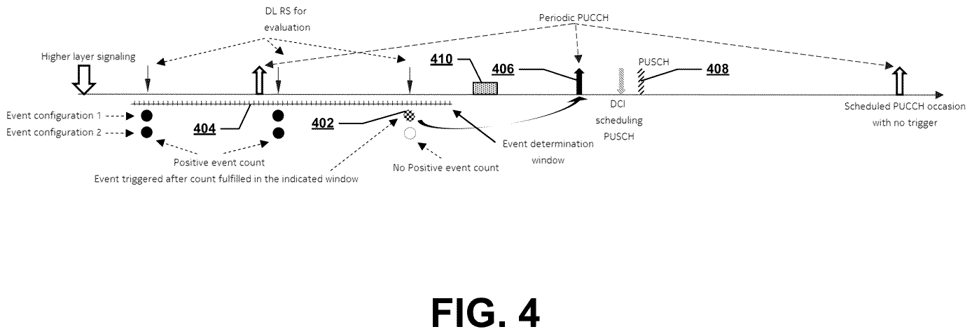

FIG. 4 illustrates example transmissions associated with a UE initiated beam management timeline that utilizes enhanced PRACH, according to one or more embodiments. For example, in UE initiated Beam Management (UEIBM), a set of events may be configured to the UE for monitoring, as illustrated in FIG. 4. For example, an event 402 may be triggered during an event determination window 404. Additionally or alternatively, the event 402 may be based on a counting operation satisfying a predefined counting threshold during the event determination window 404. For example, the event 402 may be triggered after a count for a UE is fulfilled in the event determination window 404. In some embodiments, the event 402 may be triggered when a L1-RSRP of the current serving beam is lower than a threshold. In some embodiments, the event 402 may be triggered under certain conditions such as for a consecutive amount of evaluations and during a pre-defined time window. In some embodiments, the event 402 is associated with UEIBM. In some embodiments, the event 402 is associated with CSI. In some embodiments, the event 402 is associated with reference signal density. In some embodiments, the event 402 is associated with pattern selection. However, it is to be appreciated that the event 402 may be associated with a different type of condition associated with the UE, communication network, and/or communication channel. In some embodiments, the event 402 may be triggered by comparing the L1-RSRP of a set of configured reference signals against the L1-RSRP of the current serving beam. Once the event 402 is triggered, the UE may inform the gNB by transmitting a PUCCH 406 (e.g., a 1 bit PUCCH) signaling to the gNB. In some embodiments, based on the PUCCH 406, the gNB may schedule a PUSCH transmission 408. In some embodiments, the PUSCH transmission 408 may transmit a UEIBM report. In some embodiments, in response to the event 402 being triggered, a set of PRACH sequences 410 may be transmitted. For example, the set of PRACH sequences 410 may include a physical random access preamble. The set of PRACH sequences 410, when configured for a single type of event, may correspond to a group of PRACH sequences. Additionally, when multiple events are configured, groups of PRACH sequences may corresponds to multiple event types. For example, the set of PRACH sequences 410 may correspond to a group of PRACH sequences when a single event type is configured for the event 402. In another example, the set of PRACH sequences 410 may correspond to a plurality of groups of PRACH sequences when a plurality of event types are configured for the event 402. In some embodiments, the set of PRACH sequences 410 may correspond to and/or may indicate an event type of the event 402. In some embodiments, the event type corresponds to an event type associated with a CSI.

In some embodiments, the event type corresponds to an event type associated with L1-RSRP, Layer indication, Layer imbalance indicator, CQI, PMI, RI, MCS selection, Reference signal configuration, a CPU, a control channel adaptation, a resource allocation, a multi-panel UE operation, and/or a beam failure recovery operation. For example, in UE Initiated CQI reporting, the UE may compare the CQI computed based on the serving reference signal, with one or multiple CQI values computed for other reference signals indicated by the gNB. If the later CQI is greater than the CQI computed based on the serving reference signal, an event instance is counted for a UEI CQI. In yet another example, in UE Initiated PMI reporting, the UE may compare the PMI computed based on the serving reference signal, with one or multiple PMIs computed for other reference signals indicated by the gNB. If the throughput achieved by the later PMI is greater than the throughput achieved by the PMI computed based on the serving reference signal, an event instance is counted for a UEI PMI. In yet another example, in UE Initiated Rank Indicator (RI) reporting, the UE may compare the RI computed based on the serving reference signal, with one or multiple RIs computed for other reference signals indicated by the gNB. If the throughput achieved by the later RI is greater than the throughput achieved by the RI computed based on the serving reference signal, an event instance is counted for a UEI RI. In yet another example, in UE Initiated MCS reporting, the UE may compare the MCS computed based on the serving reference signal, with one or multiple MCSs computed for other reference signals indicated by the gNB. If the throughput achieved by the later MCS is greater than the throughput achieved by the MCS computed based on the serving reference signal, an event instance is counted for a UEI MCS. In yet another example, in UE Initiated Layer Indicator (LI) reporting, the UE may compare the LI computed based on the serving reference signal, with one or multiple LIs computed for other reference signals indicated by the gNB. If the later LI is greater than the throughput achieved by the LI computed based on the serving reference signal, an event instance is counted for a UEI LI. In yet another example, in UE Initiated Layer Imbalance (LImb) reporting, the UE may compare the LImb computed based on the serving reference signal, with one or multiple LImbs computed by the UE based on different layer imbalance compensation factors. If the throughput achieved by the later LImbs is greater than the throughput achieved by the LImb computed based on the serving reference signal, an event instance is counted for a UEI LImb. In yet another example, in UE Reference signal configuration reporting, the UE may compare a UE-computed metric based on the serving reference signal configuration, with one or multiple UE-computed metrics based on other reference signals configurations such as difference time/frequency/cycling arrangements of the resource elements which are defining the reference signal pattern. If the throughput achieved by one of the later RS parameterization is greater than the throughput achieved by the serving reference signal, an event instance is counted for a UEI RS. In yet another example, in UE Initiated CPU reporting, the UE may compare the CPU needs based on the configured operations by the gNB, with one or multiple other set of operations which result in different CPU needs/budgets. If the later CPU is or smaller than the CPU achieved based on the serving reference signal, an event instance is counted for a UEI CPU. In yet another example, in UE Initiated Control Channel reporting, the UE may compare the Control Channel aggregation level and related control channel decoding needs based on the scheduled control channel information, with one or multiple other control channel aggregation levels and related control channel decoding needs which are alternative control channel scheduling variants indicated by the gNB. If the UE indicates that an alternative control channel aggregation level is better than the scheduled control channel decoding, an event instance is counted for a UEI Control Channel transmission. In yet another example, in UE Initiated Resource Allocation reporting, the UE may compare the scheduled resource allocation, with one or multiple resource allocations indicated by the gNB. If the UE indicates that an alternative resource allocation is better than the scheduled resource allocation, an event instance is counted for a UEI Resource allocation. In yet another example, in UE Initiated Multi Panel Indication, the UE may compare an existing Multi Panel operation used by the UE for an existing transmission, with one or multiple Multi Panel arrangements which are alternative transmission strategies. If the UE indicates that an alternative Multi Panel arrangement is better than the existing Multi Panel arrangement, an event instance is counted for a UEI Multi Panel Arrangement. In yet another example, in UE Initiated Beam Failure Recovery (BFR), the UE may compare an existing BFR operation used by the UE for an existing transmission, with one or multiple BFR arrangements which are alternative BFR strategies. If the UE indicates that an alternative BFR arrangement is better than the existing BFR arrangement, an event instance is counted for a UEI BFR Arrangement

In some embodiments, the set of PRACH sequences 410 corresponds to a subset of sequences associated with a contention based random access procedure. In some embodiments, the set of PRACH sequences 410 corresponds to a subset of sequences associated with a contention free random access procedure. In some embodiments, the set of PRACH sequences 410 corresponds to a PRACH root sequence associated with the event type. In some embodiments, the set of PRACH sequences 410 corresponds to a defined set of preamble indices associated with the event type. In some embodiments, the set of PRACH sequences 410 corresponds to power ramping parameterizations for the event type. In some embodiments, the set of PRACH sequences 410 is configured in a radio resource control message.

In some embodiments, the set of PRACH sequences 410 is configured in a RACH-ConfigGeneric information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type; a powerRampingStep associated with the event type, a ra-ResponseWindow associated with the event type, a msg1-FDM associated with the event type, and/or a msg1-UEI-FrequencyStart associated with the event type. The PRACH-ConfigurationIndex may be an index with a range from 0 to a defined index value. Additionally, the PRACH-ConfigurationIndex may index combinations of preamble formats, slot numbers, and/or starting symbols.

In some embodiments, the set of PRACH sequences 410 is configured with a set of PRACH-ConfigurationIndices associated with the event type. In some embodiments, the set of PRACH-ConfigurationIndices indicate a plurality of event types, a plurality of configurations of a single event type, and/or a plurality of configurations of multiple event types.

In some embodiments, the set of PRACH sequences 410 is configured in a RACH-ConfigGenericTwoStepRA information element. In some embodiments, the RACH-ConfigGenericTwoStepRA information element indicates a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

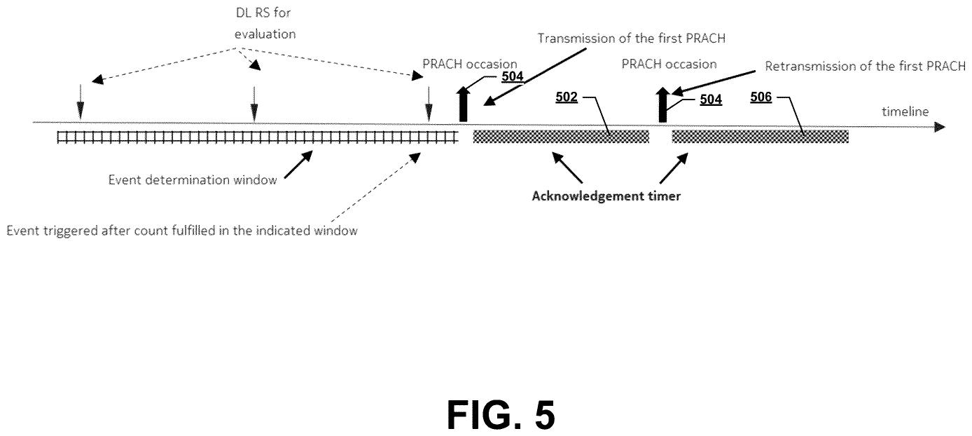

FIG. 5 illustrates example transmissions associated with a UE initiated beam management timeline that utilizes enhanced PRACH, according to one or more embodiments. For example, UE initiated beam management may utilize a set of PRACH sequences for event trigger signaling via a contention-based transmission. Additionally, an acknowledgement timer 502 may be utilized to enable positive indication of an acknowledgment of the set of PRACH sequences from a gNB. For example, after the transmission of the set of PRACH sequences 504 (e.g., the UEI sequence on a PRACH), the UE may initiate the acknowledgement timer 502 during which the UE may expect to receive an acknowledgement from the gNB with respect to a correct reception of the transmission of the set of PRACH sequences 504. In some embodiments where a scheduling DCI is not received during the acknowledgment timer 502 (e.g., which can be used as an implicit acknowledgement), the UE may retransmit the set of PRACH sequences 504. For example, in some embodiments where a scheduling DCI is not received during the acknowledgment time 502 (e.g., which can be used as an implicit acknowledgement), the UE may retransmit the UEI sequence in a next available RACH occasion or a next UEI-RACH occasion. In some embodiments, the DCI may include information indicating whether or not the UE would transmit report(s) associated to the transmitted set of PRACH sequences 504. The set of PRACH sequences 504 may be provided in the DCI, used as a CRC mask for the PDCCH carrying DCI, or used as part of the scrambling code for the PDCCH carrying DCI. In some embodiments, after retransmission of the set of PRACH sequences 504, a new acknowledgment timer 506 may be initiated during which the UE may expect to receive an acknowledgement from the gNB with respect to a correct reception of the retransmission of the set of PRACH sequences 504.

In some embodiments, the UE may monitor for an acknowledgment message via a physical downlink control channel during the acknowledgement timer 502. Additionally, in response to a determination that the acknowledgment message is not received within the acknowledgement timer 502, the UE may cause retransmission of the set of PRACH sequences 504. In some embodiments, the UE may cause the retransmission of the set of PRACH sequences 504 via a PRACH transmission occasion or a user equipment initiated transmission occasion. In some embodiments, the retransmission is conditioned on a positive triggered event in a latest evaluation window. In some embodiments, the UE may determine whether or not the acknowledgment message is received within the acknowledgment timer 502 based on a downlink control information. In some embodiments, the DCI indicates whether or not the UE is to transmit a report associated with the set of PRACH sequences 504. In some embodiments, the UE may monitor an information field associated with a DCI received via the physical downlink control channel during the acknowledgment timer 502 to determine whether or not to cause retransmission of the set of PRACH sequences 504.

In some embodiments, the set of PRACH sequences 504 corresponds to a subset of sequences associated with a contention based random access procedure. In some embodiments, the set of PRACH sequences 504 corresponds to a subset of sequences associated with a contention free random access procedure. In some embodiments, the set of PRACH sequences 504 corresponds to a PRACH root sequence associated with the event type. In some embodiments, the set of PRACH sequences 504 corresponds to a defined set of preamble indices associated with the event type. In some embodiments, the set of PRACH sequences 504 corresponds to power ramping parameterizations for the event type. In some embodiments, the set of PRACH sequences 504 is configured in a radio resource control message.

In some embodiments, the set of PRACH sequences 504 is configured in a RACH-ConfigGeneric information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type; a powerRampingStep associated with the event type, a ra-ResponseWindow associated with the event type, a msg1-FDM associated with the event type, and/or a msg1-UEI-FrequencyStart associated with the event type.

In some embodiments, the set of PRACH sequences 504 is configured with a set of PRACH-ConfigurationIndices associated with the event type. In some embodiments, the set of PRACH-ConfigurationIndices indicate a plurality of event types, a plurality of configurations of a single event type, and/or a plurality of configurations of multiple event types.

In some embodiments, the set of PRACH sequences 504 is configured in a RACH-ConfigGenericTwoStepRA information element. In some embodiments, the RACH-ConfigGenericTwoStepRA information element indicates a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

In some embodiments, a UE implementation specific procedure for a reception of acknowledgement of a correct UEI PRACH sequence transmission associated with a PRACH occasion or a UEI specific occasion is defined with one or more of the following steps:
Step 0: after the end of the UEI PRACH sequence transmission at slot n, associated with PRACH occasion or UEI specific occasion, the UE may read from UE's internal/external memory unit variable associated with the acknowledgement timer 502 and reset a value of the acknowledgement timer 502 to zero.
Step 1: at slot n+k, where k=1. . . K, the UE may monitor PDCCH with DCI format 0_x with information field for PRACH triggered CSI reporting.
Step 2: at slot n+k, if the UE detects DCI format 0_x without information field for PRACH triggered CSI reporting via DCI or if the slot n+k does not include any DCI for the UE, the UE may read the value of the acknowledgment timer 502 from UE's internal/external memory and increment a value of the acknowledgement timer 502 by one. Additionally, the UE may store the incremented value into UE's internal/external memory unit. Then, the UE may compare the stored value for the acknowledgement timer 502 against a network configured time window value associated with a PRACH triggered CSI reporting acknowledgement. In some embodiments, when the stored incremented value for the acknowledgement timer 502 is smaller than the network configured time window value, the UE may continue monitoring of DCI in the next slot as described in step 1. In some embodiments, when the stored incremental value of the acknowledgement timer 502 is greater or equal than the network configured time window value, the UE may return to an event determination phase.
Step 3: at slot n+k, if the UE detects DCI format 0_x with information field for PRACH triggered CSI reporting via DCI, the UE may read the value of the acknowledgement timer 502 from UE's internal/external memory unit and increment the value of the acknowledgement timer 502 by one. Additionally, the UE may store the incremented value of the acknowledgement timer 502 into UE's internal/external memory unit. Then, the UE may compare the stored value of the acknowledgement timer 502 against with a network configured time window value associated with a PRACH triggered CSI reporting acknowledgement. In some embodiments, when the stored incremented value of the acknowledgement timer 502 is smaller or equal to the network configured time window value, the UE may transmit CSI report obtained during an event determination phase with PUSCH according to PUSCH scheduling information via DCI format 0_x. Additionally, the UE may return to the event determination phase. In some embodiments, when the stored value of the acknowledgement timer 502 is greater than the network configured time window value, the UE may return to an event determination phase by omitting transmission of CSI report via PUSCH.

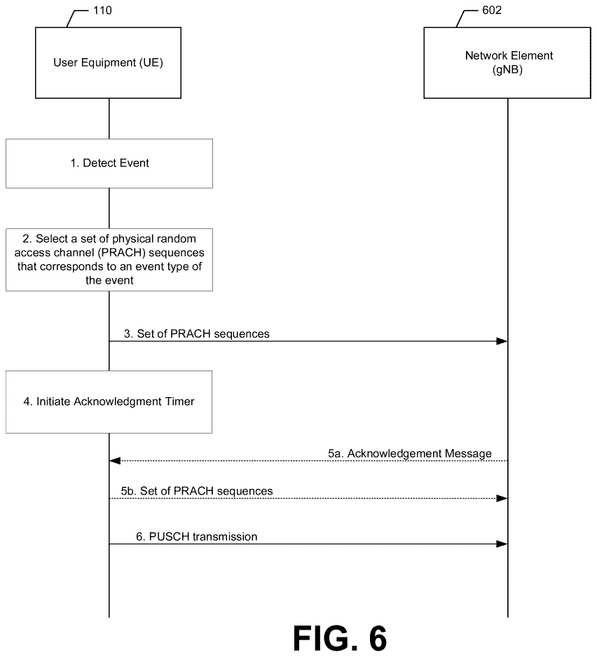

FIG. 6 illustrates example transmissions between the UE 110 and a network element 602 to enable enhanced PRACH, according to one or more embodiments. In various embodiments, the network element 602 may be a radio access node (e.g., radio access node 120A) of the communication network 100. For example, the network element 602 may be a network device (e.g., a gNB) of the communication network 100. In various embodiments, the example transmissions illustrated in FIG. 6 enable enhanced PRACH for the communication network 100.

In some embodiments, the UE 110 may detect at event, at 1. In some embodiments, the event is triggered during a time window. In some embodiments, the event is based on a counting operation satisfying a predefined counting threshold. In some embodiments, the event is associated with UEIBM. In some embodiments, the event 402 is associated with CSI. In some embodiments, the event is associated with reference signal density. In some embodiments, the event is associated with pattern selection. However, it is to be appreciated that the event may be associated with a different type of condition associated with the UE, communication network, and/or communication channel.

In some embodiments, the UE 110 may select a set of PRACH sequences that corresponds to an event type of the event, at 2. The set of PRACH sequences may be a physical random access preamble. In some embodiments, the set of PRACH sequences is configured to indicate a plurality of event types, a plurality of configurations of a single event type, and/or a plurality of configurations of multiple event types. In some embodiments, the event type corresponds to an event type associated with a CSI. In some embodiments, the event type corresponds to an event type associated with L1-RSRP, Layer indication, Layer imbalance indicator, CQI, PMI, RI, MCS selection, Reference signal configuration, a CPU, a control channel adaptation, a resource allocation, a multi-panel UE operation, and/or a beam failure recovery operation.

In some embodiments, the set of PRACH sequences corresponds to a subset of sequences associated with a contention based random access procedure. In some embodiments, the set of PRACH sequences corresponds to a subset of sequences associated with a contention free random access procedure. In some embodiments, the set of PRACH sequences corresponds to a PRACH root sequence associated with the event type. In some embodiments, the set of PRACH sequences corresponds to a defined set of preamble indices associated with the event type. In some embodiments, the set of PRACH sequences corresponds to power ramping parameterizations for the event type. In some embodiments, the set of PRACH sequences is configured in a radio resource control message.

In some embodiments, the set of PRACH sequences is configured in a RACH-ConfigGeneric information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type; a powerRampingStep associated with the event type, a ra-ResponseWindow associated with the event type, a msg1-FDM associated with the event type, and/or a msg1-UEI-FrequencyStart associated with the event type.

In some embodiments, the set of PRACH sequences is configured with a set of PRACH-ConfigurationIndices associated with the event type. In some embodiments, the set of PRACH-ConfigurationIndices indicate a plurality of event types, a plurality of configurations of a single event type, and/or a plurality of configurations of multiple event types.

In some embodiments, the set of PRACH sequences is configured in a RACH-ConfigGenericTwoStepRA information element. In some embodiments, the RACH-ConfigGenericTwoStepRA information element indicates a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

In some embodiments, the UE may transmit the set of PRACH sequences to the network element 602, at 3. In some embodiments, the UE may transmit the set of PRACH sequences to the network element 602 via a physical downlink control channel. In some embodiments, the UE may transmit the set of PRACH sequences via a PRACH transmission occasion. In some embodiments, the UE may transmit the set of PRACH sequences via a UEI transmission occasion.

In some embodiments, in response to the set of PRACH sequences being transmitted to the network element 602, the UE may initiate an acknowledgment timer, at 4. For example, the UE may initiate the acknowledgment timer based on the transmission of the set of PRACH sequences. In some embodiments, the acknowledgment timer may be configured with an acknowledgment timer value to enable monitoring of a physical downlink control channel during the acknowledgment timer and/or to determine whether or not to initiate a new event determination phase for the user equipment.

In some embodiments, the network element 602 may transmit an acknowledgment message to the UE 110 in response to the set of PRACH sequences being successfully received by the network element 602 during the acknowledgment timer, at 5a. For example, the acknowledgment message may be a random access channel response for the UE.

In some embodiments, in response a determination that the acknowledgment message is not received during the acknowledgment timer, the UE may retransmit the set of PRACH sequences to the network element 602, at 5b. For example, the UE may monitor for an acknowledgment message via the physical downlink control channel during the acknowledgement timer. Additionally, in response to a determination that the acknowledgment message is not received within the acknowledgement timer, the UE may cause retransmission of the set of PRACH sequences to the network element 602. In some embodiments, the UE may cause the retransmission of the set of PRACH sequences via a PRACH transmission occasion or a user equipment initiated transmission occasion. In some embodiments, the retransmission is conditioned on a positive triggered event in a latest evaluation window. In some embodiments, the UE may determine whether or not the acknowledgment message is received within the acknowledgment timer based on a downlink control information. In some embodiments, the DCI indicates whether or not the UE is to transmit a report associated with the set of PRACH sequences. In some embodiments, the UE may compare the acknowledgement timer value for the acknowledgement timer to a network configured time window value to determine whether or not to cause the retransmission of the set of PRACH sequences.

In some embodiments, in response a determination that the acknowledgment message is received from the network element 602, the UE 110 may provide a PUSCH transmission to the network element 602, at 6. In some embodiments, the PUSCH transmission may include channel state information. In some embodiments, the PUSCH transmission may cause initiation of a new event determination phase for the UE.

In some embodiments, based on (i) a first determination that the acknowledgement timer value is less than the network configured time window value and (ii) a second determination that an acknowledgement message is not received via the physical downlink control channel, the UE may continue monitoring of the physical downlink control channel. In some embodiments, based on (i) a first determination that the acknowledgement timer value is equal to or greater than the network configured time window value and (ii) a second determination that an acknowledgement message is not received via the physical downlink control channel, the UE may initiate a new event determination phase for the user equipment initiated event type. In some embodiments, based on (i) a first determination that the acknowledgement timer value is less than the network configured time window value and (ii) a second determination that an acknowledgement message is received via the physical downlink control channel, the UE may cause transmission of channel state information via a PUSCH.

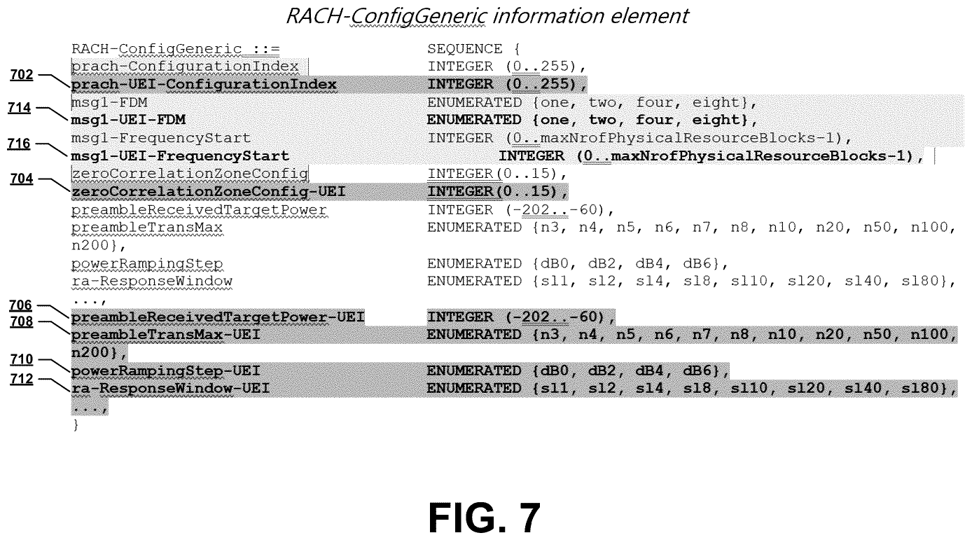

FIG. 7 illustrates an example RACH-ConfigGeneric information element associated with a set of PRACH sequences, according to one or more embodiments. In some embodiments, the RACH-ConfigGeneric information element indicates a PRACH-ConfigurationIndex 702 associated with user equipment initiated event type, a zeroCorrelationZoneConfig 704 associated with user equipment initiated event type, a preambleReceivedTargetPower 706 associated with user equipment initiated event type, a preambleTransMax 708 associated with user equipment initiated event type, a powerRampingStep 710 associated with user equipment initiated event type, a ra-ResponseWindow 712 associated with user equipment initiated event type, a msg1-FDM associated with user equipment initiated event type, and/or a msg1-UEI-FrequencyStart associated with user equipment initiated event type.

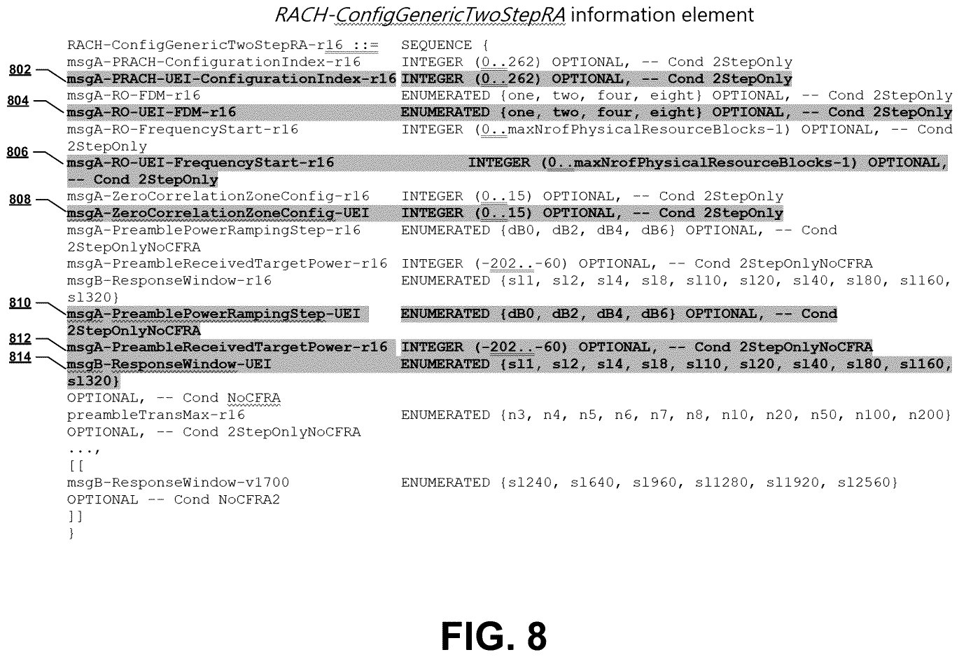

FIG. 8 illustrates an example RACH-ConfigGenericTwoStepRA information element associated with a set of PRACH sequences, according to one or more embodiments. In some embodiments, the RACH-ConfigGenericTwoStepRA information element indicates a msgA-PRACH-ConfigurationIndex 802 associated with user equipment initiated event type, a msgA-RO-FDM 804 associated with user equipment initiated event type, a msgA-RO-FrequencyStart 806 associated with user equipment initiated event type, a msgA-ZeroCorrelationZoneConfig 808 associated with user equipment initiated event type, a msgA-PreamblePowerRampingStep 810 associated with user equipment initiated event type, a msgA-PreambleReceivedTargetPower 812 associated with user equipment initiated event type, and/or a msgB-ResponseWindow 814 associated with user equipment initiated event type.

In an embodiment, at least some of the processes described herein may be carried out by an apparatus comprising means for carrying out at least some of the described processes. Means for performing method operations as disclosed herein may include software and/or hardware components (e.g., 110, 120, 220, 230, 320, 330) of the apparatus. For example, at least one processor and at least one memory storing thereon computer program codes can comprise means for carrying out the method or methods as disclosed herein, and any of the embodiments thereof. As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

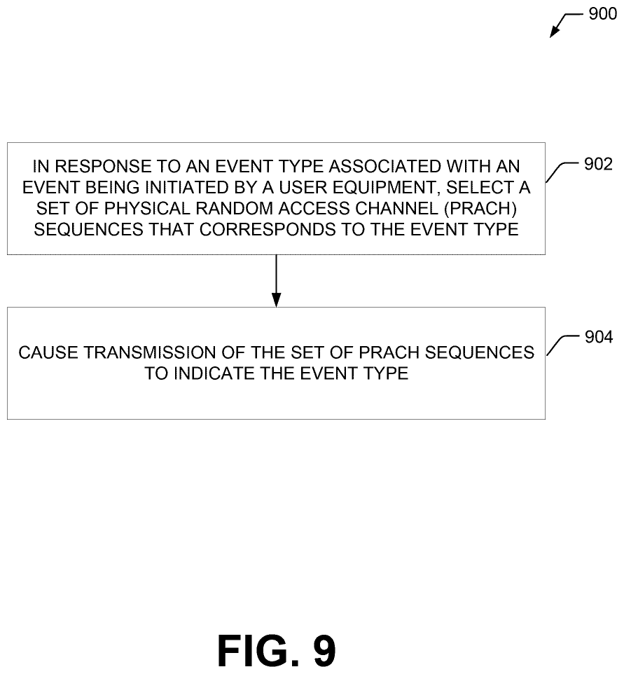

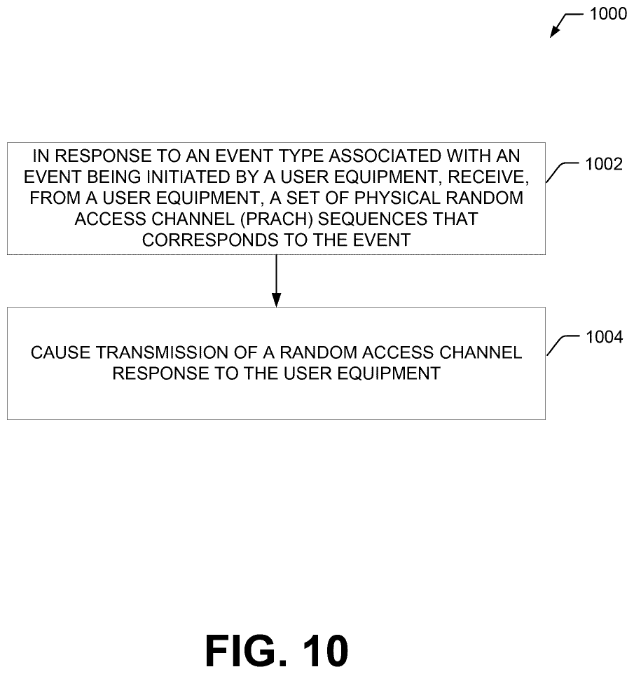

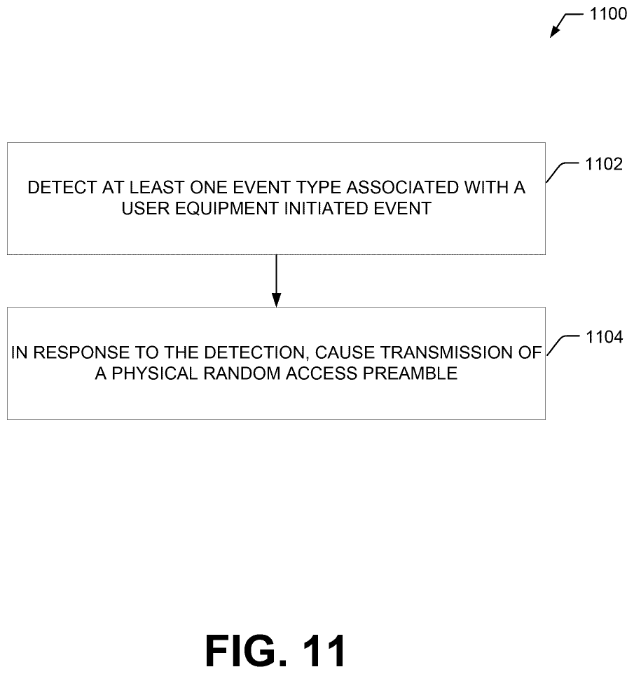

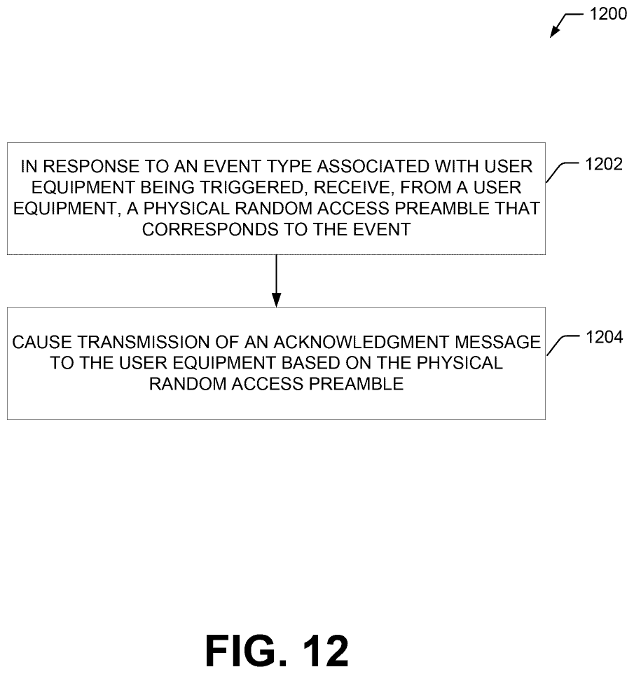

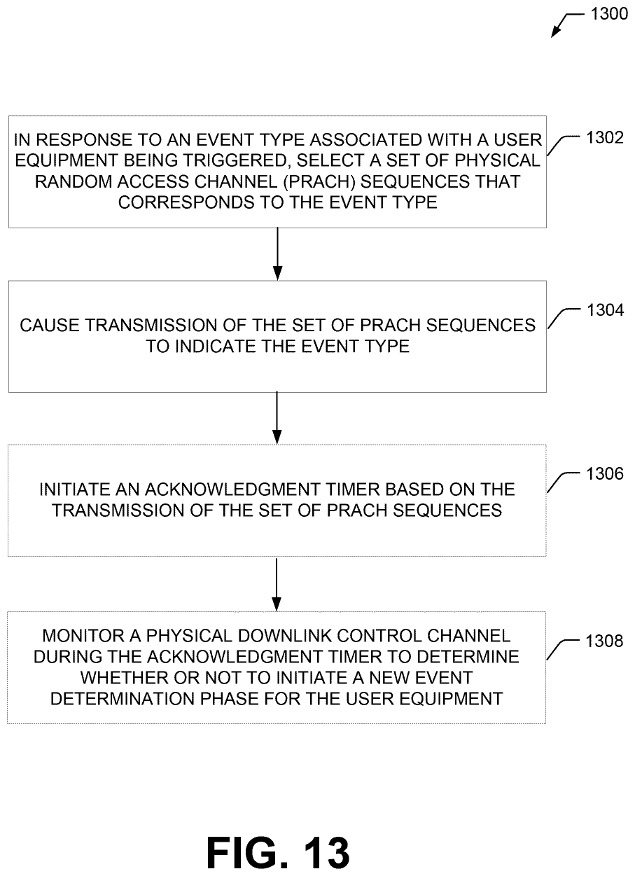

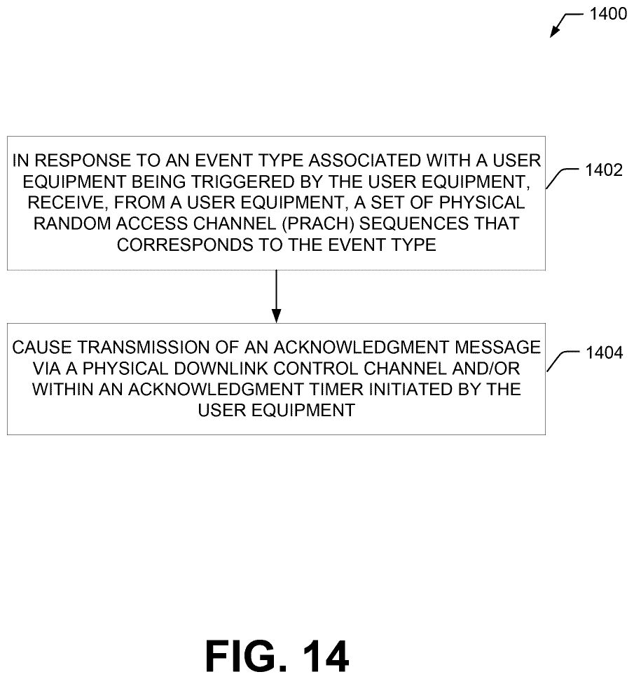

FIG. 9 illustrates a flowchart depicting a method 900, FIG. 10 illustrates a flowchart depicting a method 1000, FIG. 11 illustrates a flowchart depicting a method 1100, FIG. 12 illustrates a flowchart depicting a method 1200, FIG. 13 illustrates a flowchart depicting a method 1300, and FIG. 14 illustrates a flowchart depicting a method 1400 according to one or more example embodiments of the present disclosure. It will be understood that each block of the flowcharts and combination of blocks in the flowcharts can be implemented by various means, such as hardware, firmware, processor, circuitry, and/or other communication devices associated with execution of software including instructions, for example one or more computer program instructions. For example, one or more of the procedures described above can be embodied by computer program instructions. In some embodiments, the computer program instructions which embody the procedures described above can be stored, for example, by the memory 230 of the apparatus illustrated in FIG. 2 employing an embodiment of the present disclosure and executed by the processor 220. In some embodiments, the computer program instructions which embody the procedures described above can be stored, for example, by the memory 330 of the apparatus illustrated in FIG. 3 employing an embodiment of the present disclosure and executed by the processor 320. As will be appreciated, any such computer program instructions can be loaded onto a computer or other programmable apparatus (for example, hardware) to produce a machine, such that the resulting computer or other programmable apparatus implements the functions specified in the flowchart blocks. These computer program instructions can also be stored in a computer-readable memory that can direct a computer or other programmable apparatus to function in a particular manner, such that the instructions stored in the computer-readable memory produce an article of manufacture the execution of which implements the function specified in the flowchart blocks. The computer program instructions can also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Referring now to FIG. 9, the operations performed, such as by the apparatus (e.g., the apparatus for the UE 110) illustrated in FIG. 2, enable enhanced PRACH for a communication network, in accordance with one or more embodiments of the present disclosure. In some embodiments, the method 900 is associated with functionality of the UE 110.

As shown in block 902 of FIG. 9, in response to an event type associated with an event being initiated by a user equipment, the apparatus (e.g., the apparatus for the UE 110) includes means, such as the processor 220, the memory 230, or the like, configured to select a set of physical random access channel (PRACH) sequences that corresponds to the event type. In some embodiments, the event type is initiated by the user equipment during a time window. In some embodiments, the event type is initiated by the user equipment based on a counting operation satisfying a predefined counting threshold. As shown in block 904 of FIG. 9, the apparatus (e.g., the apparatus for the UE 110) includes means, such as the processor 220, the memory 230, or the like, configured to cause transmission of the set of PRACH sequences to indicate the event type.

In some embodiments, the set of PRACH sequences corresponds to a subset of sequences associated with a contention based random access procedure. In some embodiments, the set of PRACH sequences corresponds to a subset of sequences associated with a contention free random access procedure. In some embodiments, the set of PRACH sequences corresponds to a PRACH root sequence associated with the event type. In some embodiments, the set of PRACH sequences corresponds to a defined set of preamble indices associated with the event type. In some embodiments, the set of PRACH sequences corresponds to power ramping parameterizations for the event type. In some embodiments, the set of PRACH sequences is configured in a radio resource control message.

In some embodiments, the set of PRACH sequences is configured in a RACH-ConfigGeneric information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type; a powerRampingStep associated with the event type, a ra-ResponseWindow associated with the event type, a msg1-FDM associated with the event type, and/or a msg1-UEI-FrequencyStart associated with the event type.

In some embodiments, the set of PRACH sequences is configured to indicate a plurality of event types, a plurality of configurations of a single event type, and/or a plurality of configurations of multiple event types.

In some embodiments, the set of PRACH sequences is configured with a set of PRACH-ConfigurationIndices associated with the event type. In some embodiments, the set of PRACH-ConfigurationIndices indicate a plurality of event types, a plurality of configurations of a single event type, and/or a plurality of configurations of multiple event types.

In some embodiments, the set of PRACH sequences is configured in a RACH-ConfigGenericTwoStepRA information element. In some embodiments, the RACH-ConfigGenericTwoStepRA information element indicates a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

In some embodiments, the event type corresponds to an event type associated with a CSI. In some embodiments, the event type corresponds to an event type associated with L1-RSRP, Layer indication, Layer imbalance indicator, CQI, PMI, RI, MCS selection, Reference signal configuration, a CPU, a control channel adaptation, a resource allocation, a multi-panel UE operation, and/or a beam failure recovery operation.

In some embodiments, the event is triggered during a time window. In some embodiments, the event is based on a counting operation satisfying a predefined counting threshold.

In some embodiments, the set of PRACH sequences corresponds to a group of PRACH sequences when a single event type is configured. In some embodiments, the set of PRACH sequences corresponds to a group of sequences selected from a plurality of groups of PRACH sequences when a plurality of event types are configured.

Referring now to FIG. 10, the operations performed, such as by the apparatus (e.g., the apparatus for the radio access node 120 or the network node 130) illustrated in FIG. 3, enable enhanced PRACH for a communication network, in accordance with one or more embodiments of the present disclosure. In some embodiments, the method 1000 is associated with functionality of the network element 602. In some embodiments, the event type is initiated by the user equipment during a time window. In some embodiments, the event type is initiated by the user equipment based on a counting operation satisfying a predefined counting threshold. As shown in block 1002 of FIG. 10, in response to an event type associated with an event being initiated by a user equipment, the apparatus (e.g., the apparatus for the radio access node 120 or the network node 130) includes means, such as the processor 320, the memory 330, or the like, configured to receive, from a user equipment, a set of physical random access channel (PRACH) sequences that corresponds to the event.

As shown in block 1004 of FIG. 10, the apparatus (e.g., the apparatus for the radio access node 120 or the network node 130) includes means, such as the processor 320, the memory 330, or the like, configured to cause transmission of a random access channel response to the user equipment.

In some embodiments, the set of PRACH sequences corresponds to a subset of sequences associated with a contention based random access procedure. In some embodiments, the set of PRACH sequences corresponds to a subset of sequences associated with a contention free random access procedure. In some embodiments, the set of PRACH sequences corresponds to a PRACH root sequence associated with the event type. In some embodiments, the set of PRACH sequences corresponds to a defined set of preamble indices which is different from a set of PRACH sequences associated with a contention based random access procedure and/or a contention free random access procedure. In some embodiments, the set of PRACH sequences corresponds to power ramping parameterizations for the event type. In some embodiments, the set of PRACH sequences is configured in a radio resource control message.

In some embodiments, the set of PRACH sequences is configured in a RACH-ConfigGeneric information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, and/or a msg1-UEI-FrequencyStart associated with the event type.

In some embodiments, the set of PRACH sequences is defined based on a PRACH-UEI-ConfigurationIndex configured with at least one event type and two or more different configurations for a respective event type of the at least one event type. In some embodiments, the two or more different configurations are defined based on different parameter subsets associated with a RACH occasion resource element.

In some embodiments, the set of PRACH sequences is configured in a RACH-ConfigGenericTwoStepRA information element. In some embodiments, the RACH-ConfigGenericTwoStepRA information element indicates a msgA-PRACH-ConfigurationIndex associated with the event type, a msgA-RO-FDM associated with user equipment initiated event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

In some embodiments, the event corresponds to a user equipment initiated (UEI) event. In some embodiments, the event type corresponds to an event type associated with a CSI. In some embodiments, the event type corresponds to an event type associated with L1-RSRP, Layer indication, Layer imbalance indicator, CQI, PMI, RI, MCS selection, Reference signal configuration, a CPU, a control channel adaptation, a resource allocation, a multi-panel UE operation, and/or a beam failure recovery operation.

In some embodiments, the event is triggered during a time window. In some embodiments, the event is triggered based on a counting operation satisfying a predefined counting threshold.

In some embodiments, the set of PRACH sequences corresponds to a group of PRACH sequences when a single event type is configured. In some embodiments, the set of PRACH sequences corresponds to a group of sequences selected from a plurality of groups of PRACH sequences when a plurality of event types are configured.

Referring now to FIG. 11, the operations performed, such as by the apparatus (e.g., the apparatus for the UE 110) illustrated in FIG. 2, enable enhanced PRACH for a communication network, in accordance with one or more embodiments of the present disclosure. In some embodiments, the method 1100 is associated with functionality of the UE 110.

As shown in block 1102 of FIG. 11, the apparatus (e.g., the apparatus for the UE 110) includes means, such as the processor 220, the memory 230, or the like, configured to detect at least one event type associated with a user equipment initiated event. In some embodiments, detecting the at least one event type comprises detecting the event type during a time window associated with the user equipment. In some embodiments, detecting the at least one event type comprises detecting an event type based on a counting operation satisfying a predefined counting threshold associated with a user equipment.

As shown in block 1104 of FIG. 11, in response to the detection, the apparatus (e.g., the apparatus for the UE 110) includes means, such as the processor 220, the memory 230, or the like, configured to cause transmission of a physical random access preamble.

In some embodiments, the apparatus (e.g., the apparatus for the UE 110) includes means, such as the processor 220, the memory 230, or the like, configured to cause the transmission of the physical random access preamble via a physical random access channel (PRACH) transmission occasion.

In some embodiments, the apparatus (e.g., the apparatus for the UE 110) includes means, such as the processor 220, the memory 230, or the like, configured to cause the transmission of the physical random access preamble via a user equipment initiated (UEI) transmission occasion.

In some embodiments, the physical random access preamble indicates the at least one event type and/or at least one configuration of the at least one event type.

In some embodiments, the physical random access preamble is configured in a time division multiplexing format.

In some embodiments, the apparatus (e.g., the apparatus for the UE 110) includes means, such as the processor 220, the memory 230, or the like, configured to initiate an acknowledgment timer associated with an interval of time for receiving an acknowledgment message from the network device. In some embodiments, in response to a determination that the acknowledgment message is not received within the interval of time, the apparatus (e.g., the apparatus for the UE 110) includes means, such as the processor 220, the memory 230, or the like, configured to cause retransmission of the physical random access preamble to the network device.

In some embodiments, causing the retransmission of the physical random access preamble comprises causing the retransmission of the physical random access preamble via a physical random access channel (PRACH) transmission occasion or a user equipment initiated transmission occasion. In some embodiments, the retransmission is conditioned on a positive triggered event in a latest evaluation window.

In some embodiments, the apparatus (e.g., the apparatus for the UE 110) includes means, such as the processor 220, the memory 230, or the like, configured to determine whether or not the acknowledgment message is received within the interval of time based on a downlink control information. In some embodiments, the DCI indicates whether or not the method is to transmit a report associated with the physical random access preamble.

Referring now to FIG. 12, the operations performed, such as by the apparatus (e.g., the apparatus for the radio access node 120 or the network node 130) illustrated in FIG. 3, enable enhanced PRACH for a communication network, in accordance with one or more embodiments of the present disclosure. In some embodiments, the method 1200 is associated with functionality of the network element 602.

As shown in block 1202 of FIG. 12, in response to an event type associated with user equipment being triggered, the apparatus (e.g., the apparatus for the radio access node 120 or the network node 130) includes means, such as the processor 320, the memory 330, or the like, configured to receive, from a user equipment, a physical random access preamble that corresponds to the event.

As shown in block 1204 of FIG. 12, the apparatus (e.g., the apparatus for the radio access node 120 or the network node 130) includes means, such as the processor 320, the memory 330, or the like, configured to cause transmission of an acknowledgment message to the user equipment based on the physical random access preamble.

In some embodiments, the apparatus (e.g., the apparatus for the radio access node 120 or the network node 130) includes means, such as the processor 320, the memory 330, or the like, configured to receive the physical random access preamble via a physical random access channel (PRACH) transmission occasion.

In some embodiments, the apparatus (e.g., the apparatus for the radio access node 120 or the network node 130) includes means, such as the processor 320, the memory 330, or the like, configured to receive the physical random access preamble via a user equipment initiated (UEI) transmission occasion.

In some embodiments, the physical random access preamble indicates the event.

In some embodiments, the event is a first event. In some embodiments, the physical random access preamble indicates the first event and a second event associated with the user equipment initiated beam management.

In some embodiments, the physical random access preamble is configured in a time division multiplexing format.

In some embodiments, causing the transmission of the acknowledgement message comprises causing the transmission of the acknowledgment message within an interval of time established by an acknowledgment timer policy.

Referring now to FIG. 13, the operations performed, such as by the apparatus (e.g., the apparatus for the UE 110) illustrated in FIG. 2, enable enhanced PRACH for a communication network, in accordance with one or more embodiments of the present disclosure. In some embodiments, the method 1300 is associated with functionality of the UE 110.

As shown in block 1302 of FIG. 13, in response to an event type associated with a user equipment being triggered, the apparatus (e.g., the apparatus for the UE 110) includes means, such as the processor 220, the memory 230, or the like, configured to select a set of physical random access channel (PRACH) sequences that corresponds to the event type

As shown in block 1304 of FIG. 13, the apparatus (e.g., the apparatus for the UE 110) includes means, such as the processor 220, the memory 230, or the like, configured to cause transmission of the set of PRACH sequences to indicate the event type.

In some embodiments, as shown in block 1306 of FIG. 13, the apparatus (e.g., the apparatus for the UE 110) includes means, such as the processor 220, the memory 230, or the like, configured to initiate an acknowledgment timer based on the transmission of the set of PRACH sequences.

In some embodiments, as shown in block 1308 of FIG. 13, the apparatus (e.g., the apparatus for the UE 110) includes means, such as the processor 220, the memory 230, or the like, configured to monitor a physical downlink control channel during the acknowledgment timer to determine whether or not to initiate a new event determination phase for the user equipment.

In some embodiments, the apparatus (e.g., the apparatus for the UE 110) includes means, such as the processor 220, the memory 230, or the like, configured to cause the transmission of the set of PRACH sequences via a PRACH transmission occasion.

In some embodiments, the apparatus (e.g., the apparatus for the UE 110) includes means, such as the processor 220, the memory 230, or the like, configured to cause the transmission of the set of PRACH sequences via a user equipment initiated (UEI) transmission occasion.

In some embodiments, the apparatus (e.g., the apparatus for the UE 110) includes means, such as the processor 220, the memory 230, or the like, configured to monitor for an acknowledgment message via the physical downlink control channel during the acknowledgement timer. In some embodiments, in response to a determination that the acknowledgment message is not received within the acknowledgement timer, the apparatus (e.g., the apparatus for the UE 110) includes means, such as the processor 220, the memory 230, or the like, configured to cause retransmission of the set of PRACH sequences to the network device.

In some embodiments, the apparatus (e.g., the apparatus for the UE 110) includes means, such as the processor 220, the memory 230, or the like, configured to cause the retransmission of the set of PRACH sequences via a PRACH transmission occasion or a user equipment initiated transmission occasion. In some embodiments, the retransmission is conditioned on a positive triggered event in a latest evaluation window.

In some embodiments, the apparatus (e.g., the apparatus for the UE 110) includes means, such as the processor 220, the memory 230, or the like, configured to determine whether or not the acknowledgment message is received within the acknowledgment timer based on a downlink control information. In some embodiments, the DCI indicates whether or not the apparatus is to transmit a report associated with the set of PRACH sequences.

In some embodiments, the apparatus (e.g., the apparatus for the UE 110) includes means, such as the processor 220, the memory 230, or the like, configured to compare the acknowledgement timer value for the acknowledgement timer to a network configured time window value. In some embodiments, based on (i) a first determination that the acknowledgement timer value is less than the network configured time window value and (ii) a second determination that an acknowledgement message is not received via the physical downlink control channel, the apparatus (e.g., the apparatus for the UE 110) includes means, such as the processor 220, the memory 230, or the like, configured to continue monitoring of the physical downlink control channel.

In some embodiments, the apparatus (e.g., the apparatus for the UE 110) includes means, such as the processor 220, the memory 230, or the like, configured to compare the acknowledgement timer value for the acknowledgement timer to a network configured time window value. In some embodiments, based on (i) a first determination that the acknowledgement timer value is equal to or greater than the network configured time window value and (ii) a second determination that an acknowledgement message is not received via the physical downlink control channel, the apparatus (e.g., the apparatus for the UE 110) includes means, such as the processor 220, the memory 230, or the like, configured to initiate the new event determination phase for the user equipment initiated event type.

In some embodiments, the apparatus (e.g., the apparatus for the UE 110) includes means, such as the processor 220, the memory 230, or the like, configured to compare the acknowledgement timer value for the acknowledgement timer to a network configured time window value. In some embodiments, based on (i) a first determination that the acknowledgement timer value is less than the network configured time window value and (ii) a second determination that an acknowledgement message is received via the physical downlink control channel, the apparatus (e.g., the apparatus for the UE 110) includes means, such as the processor 220, the memory 230, or the like, configured to cause transmission of channel state information via a physical uplink shared channel (PUSCH).

In some embodiments, the apparatus (e.g., the apparatus for the UE 110) includes means, such as the processor 220, the memory 230, or the like, configured to cause transmission of channel state information via a time slot associated with a PUSCH scheduling offset.

In some embodiments, the apparatus (e.g., the apparatus for the UE 110) includes means, such as the processor 220, the memory 230, or the like, configured to compare the acknowledgement timer value for the acknowledgement timer to a network configured time window value. In some embodiments, based on (i) a first determination that the acknowledgement timer value is equal to or greater than the network configured time window value and (ii) a second determination that an acknowledgement message is received via the physical downlink control channel, the apparatus (e.g., the apparatus for the UE 110) includes means, such as the processor 220, the memory 230, or the like, configured to withhold transmission of channel state information via a physical uplink shared channel and initiate the new event determination phase for the user equipment initiated event type.

In some embodiments, the apparatus (e.g., the apparatus for the UE 110) includes means, such as the processor 220, the memory 230, or the like, configured to monitor an information field associated with downlink control information received via the physical downlink control channel during the acknowledgment timer to determine whether or not to initiate the new event determination phase for the user equipment initiated event type.

In some embodiments, the set of PRACH sequences is configured to indicate a plurality of event types, a plurality of configurations of a single event type, and/or a plurality of configurations of multiple event types.

In some embodiments, the set of PRACH sequences is configured in a RACH-ConfigGeneric information element or a RACH-ConfigGenericTwoStepRA information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, and/or a msg1-UEI-FrequencyStart associated with the event type. In some embodiments, the RACH-ConfigGenericTwoStepRA information element indicates a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

In some embodiments, the apparatus is the user equipment. In some embodiments, the apparatus is comprised in the user equipment.

In some embodiments, the set of PRACH sequences corresponds to a group of PRACH sequences when a single event type is configured. In some embodiments, the set of PRACH sequences corresponds to a group of sequences selected from a plurality of groups of PRACH sequences when a plurality of event types are configured.

Referring now to FIG. 14, the operations performed, such as by the apparatus (e.g., the apparatus for the radio access node 120 or the network node 130) illustrated in FIG. 3, enable enhanced PRACH for a communication network, in accordance with one or more embodiments of the present disclosure. In some embodiments, the method 1400 is associated with functionality of the network element 602.

As shown in block 1402 of FIG. 14, in response to an event type associated with a user equipment being triggered by the user equipment, the apparatus (e.g., the apparatus for the radio access node 120 or the network node 130) includes means, such as the processor 320, the memory 330, or the like, configured to receive, from a user equipment, a set of physical random access channel (PRACH) sequences that corresponds to the event type.

As shown in block 1404 of FIG. 14, the apparatus (e.g., the apparatus for the radio access node 120 or the network node 130) includes means, such as the processor 320, the memory 330, or the like, configured to cause transmission of an acknowledgment message via a physical downlink control channel and/or within an acknowledgment timer initiated by the user equipment.

In some embodiments, the set of PRACH sequences is configured to indicate a plurality of event types, a plurality of configurations of a single event type, and/or a plurality of configurations of multiple event types.

In some embodiments, the set of PRACH sequences is configured in a RACH-ConfigGeneric information element or a RACH-ConfigGenericTwoStepRA information element. In some embodiments, the RACH-ConfigGeneric information element indicates a PRACH-ConfigurationIndex associated with the event type, a zeroCorrelationZoneConfig associated with the event type, a preambleReceivedTargetPower associated with the event type, a preambleTransMax associated with the event type, a powerRampingStep associated with the event type, a ra-ResponseWindow associated with the event type, a msg1-FDM associated with the event type, and/or a msg1-UEI-FrequencyStart associated with the event type. In some embodiments, the RACH-ConfigGenericTwoStepRA information element indicates a msgA-PRACH-ConfigurationIndex associated with the event type, a msgA-RO-FDM associated with the event type, a msgA-RO-FrequencyStart associated with the event type, a msgA-ZeroCorrelationZoneConfig associated with the event type, a msgA-PreamblePowerRampingStep associated with the event type, a msgA-PreambleReceivedTargetPower associated with the event type, and/or a msgB-ResponseWindow associated with the event type.

In some embodiments, the set of PRACH sequences corresponds to a group of PRACH sequences when a single event type is configured. In some embodiments, the set of PRACH sequences corresponds to a group of sequences selected from a plurality of groups of PRACH sequences when a plurality of event types are configured.

The herein described procedures may be applied per model or per functionality level (identified by an identifier) or across models or functionalities of a given entity, e.g., as a UE feature. It should be understood that the apparatuses described herein may comprise or be coupled to other units or modules etc., such as radio parts or radio heads, used in or for transmission and/or reception. Although the apparatuses have been described as one entity, different modules and memory may be implemented in one or more physical or logical entities.

It is noted that although embodiments have been described in relation to LTE and 5G NR, similar principles may be applied in relation to other networks and communication systems where enforcing fast connection re-establishment is required. Therefore, although certain embodiments were described above by way of example with reference to certain example architectures for wireless networks, technologies and standards, embodiments may be applied to any other suitable forms of communication systems than those illustrated and described herein.

It is also noted herein that although the above describes example embodiments, there are several variations and modifications which may be made to the disclosed solution without departing from the scope of the subject disclosure.

In general, the various example embodiments may be implemented in hardware or special purpose circuits, software, logic or any combination thereof. Some aspects of the subject disclosure may be implemented in hardware, whereas other aspects may be implemented in firmware or software which may be executed by a controller, microprocessor or other computing device, although the subject disclosure is not limited thereto. Although various aspects of the subject disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Example embodiments of the subject disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the figures may represent program processes, or interconnected logic circuits, blocks and functions, or a combination of program processes and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may comprise one or more of general-purpose computers, special purpose computers, microprocessors, digital signal processors (DSPs), application specific integrated circuits (ASICs), FPGA, gate level circuits and processors based on multi-core processor architecture, as non-limiting examples.

Example embodiments of the subject disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Moreover, in accordance with the foregoing description, the embodiments described herein reflect possible embodiments of the herein presented solution, which are further combinable between embodiments and/or sets of embodiments. These embodiments do not define the entire scope of the disclosure of this application; nor do these embodiments define or limit the scope of the disclosure.

The above-noted aspects and features may be implemented in systems, apparatuses, methods, articles and non-transitory computer-readable media depending on the desired configuration. The subject disclosure may be implemented in and used with a number of different types of devices, including but not limited to cellular phones, tablet computers, wearable computing devices, portable media players, and any of various other computing devices.

The foregoing description has provided by way of non-limiting examples a full and informative description of the example embodiment of the subject disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of the subject disclosure as defined in the appended claims. Indeed, there is a further embodiment comprising a combination of one or more embodiments with any of the other embodiments previously discussed.

Even though the disclosure has been described above with reference to an example according to the accompanying drawings, it is clear that the disclosure is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

With regard to the illustrated signal flow diagrams and flowcharts depicting methods provided in the drawings and described above, it will be understood that each block or signal and combination of blocks and signals may be implemented by various means, such as hardware, firmware, processor, circuitry, and/or other communication devices associated with execution of software including one or more computer program instructions.

For example, one or more of the procedures described above may be embodied by computer program instructions. In this regard, the computer program instructions which embody the procedures described above may be stored by a memory of the apparatus employing an example embodiment and executed by processing circuitry, such as a processor. As will be appreciated, any such computer program instructions, such as instructions, may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising:
at least one processor; and
at least one memory storing instructions that, when executed by the at least one processor, cause the apparatus to:
in response to an event type associated with a user equipment being triggered, select a set of physical random access channel (PRACH) sequences that corresponds to the event type;
cause transmission of the set of PRACH sequences to indicate the event type;
initiate an acknowledgment timer based on the transmission of the set of PRACH sequences; and
monitor a physical downlink control channel during the acknowledgment timer to determine whether or not to initiate a new event determination phase for the user equipment.

2. The apparatus of claim 1, further caused to:
cause the transmission of the set of PRACH sequences via a PRACH transmission occasion.

3. The apparatus of claim 1, further caused to:
cause the transmission of the set of PRACH sequences via a user equipment initiated (UEI) transmission occasion.

4. The apparatus of claim 1, further caused to:
monitor for an acknowledgment message via the physical downlink control channel during the acknowledgement timer; and
in response to a determination that the acknowledgment message is not received within the acknowledgement timer, cause retransmission of the set of PRACH sequences to the network device.

5. The apparatus of claim 4, further caused to:
cause the retransmission of the set of PRACH sequences via a PRACH transmission occasion or a user equipment initiated transmission occasion.

6. The apparatus of claim 4, wherein the retransmission is conditioned on a positive triggered event in a latest evaluation window.

7. The apparatus of claim 4, further caused to:
determine whether or not the acknowledgment message is received within the acknowledgment timer based on a downlink control information (DCI), and wherein the DCI indicates whether or not the apparatus is to transmit a report associated with the set of PRACH sequences.

8. The apparatus of claim 1, further caused to:
compare the acknowledgement timer value for the acknowledgement timer to a network configured time window value; and
based on (i) a first determination that the acknowledgement timer value is less than the network configured time window value and (ii) a second determination that an acknowledgement message is not received via the physical downlink control channel, continue monitoring of the physical downlink control channel.

9. The apparatus of claim 1, further caused to:
compare the acknowledgement timer value for the acknowledgement timer to a network configured time window value; and
based on (i) a first determination that the acknowledgement timer value is equal to or greater than the network configured time window value and (ii) a second determination that an acknowledgement message is not received via the physical downlink control channel, initiate the new event determination phase for the user equipment initiated event type.

10. The apparatus of claim 1, further caused to:
compare the acknowledgement timer value for the acknowledgement timer to a network configured time window value; and
based on (i) a first determination that the acknowledgement timer value is less than the network configured time window value and (ii) a second determination that an acknowledgement message is received via the physical downlink control channel, cause transmission of channel state information via a physical uplink shared channel (PUSCH).

11. The apparatus of claim 10, further caused to:
cause transmission of channel state information via a time slot associated with a PUSCH scheduling offset.

12. The apparatus of claim 1, further caused to:
compare an acknowledgement timer value for the acknowledgement timer to a network configured time window value; and
based on (i) a first determination that the acknowledgement timer value is equal to or greater than the network configured time window value and (ii) a second determination that an acknowledgement message is received via the physical downlink control channel, withhold transmission of channel state information via a physical uplink shared channel and initiate the new event determination phase for the user equipment initiated event type.

13. The apparatus of claim 1, further caused to:
monitor an information field associated with downlink control information received via the physical downlink control channel during the acknowledgment timer to determine whether or not to initiate the new event determination phase for the user equipment initiated event type.

14. The apparatus of claim 1, wherein the set of PRACH sequences is configured to indicate at least one of: a plurality of event types, a plurality of configurations of a single event type, or a plurality of configurations of multiple event types.

15. The apparatus of claim 1, wherein the set of PRACH sequences is configured in a RACH-ConfigGeneric information element or a RACH-ConfigGenericTwoStepRA information element.

16. The apparatus of claim 15, wherein the RACH-ConfigGeneric information element indicates at least one of:
a PRACH-ConfigurationIndex associated with the event type,
a zeroCorrelationZoneConfig associated with the event type,
a preambleReceivedTargetPower associated with the event type,
a preambleTransMax associated with the event type,
a powerRampingStep associated with the event type,
a ra-ResponseWindow associated with the event type,
a msg1-FDM associated with the event type, or
a msg1-UEI-FrequencyStart associated with the event type.

17. The apparatus of claim 15, wherein the RACH-ConfigGenericTwoStepRA information element indicates at least one of:
a msgA-PRACH-ConfigurationIndex associated with the event type,
a msgA-RO-FDM associated with the event type,
a msgA-RO-FrequencyStart associated with the event type,
a msgA-ZeroCorrelationZoneConfig associated with the event type,
a msgA-PreamblePowerRampingStep associated with the event type,
a msgA-PreambleReceivedTargetPower associated with the event type, or
a msgB-ResponseWindow associated with the event type.

18. The apparatus of claim 1, wherein the apparatus is the user equipment, or wherein the apparatus is comprised in the user equipment.

19. A method comprising:
in response to an event type associated with a user equipment being triggered, selecting a set of physical random access channel (PRACH) sequences that corresponds to the event type;
causing transmission of the set of PRACH sequences to indicate the event type;
initiating an acknowledgment timer based on the transmission of the set of PRACH sequences; and
monitoring a physical downlink control channel during the acknowledgment timer to determine whether or not to initiate a new event determination phase for the user equipment.

20. A computer system comprising:
one or more processors;
at least one data storage; and
one or more computer program instructions, to be executed by the one or more processors in association with the at least one data storage, that are configured to:
in response to an event type associated with a user equipment being triggered, select a set of physical random access channel (PRACH) sequences that corresponds to the event type;
cause transmission of the set of PRACH sequences to indicate the event type;
initiate an acknowledgment timer based on the transmission of the set of PRACH sequences; and
monitor a physical downlink control channel during the acknowledgment timer to determine whether or not to initiate a new event determination phase for the user equipment.
